(19) United States
(12) Patent Application Publication
(10) Pub. No.: US 2024/0148573 A1
(43) Pub. Date: May 9, 2024

(54) Patient Transport Apparatus With Motorized Track Assembly And Battery System

(71) Applicant: Stryker Corporation, Kalamazoo, MI (US)

(72) Inventors: Daniel V. Brosnan, Kalamazoo, MI (US); Jason Anthony Vanderplas, Kalamazoo, MI (US)

(73) Assignee: Stryker Corporation, Kalamazoo, MI (US)

(21) Appl. No.: 18/191,277

(22) Filed: Mar. 28, 2023

Related U.S. Application Data
(60) Provisional application No. 63/423,646, filed on Nov. 8, 2022.

(51) Int. Cl. A61G 5/04; A61G 5/06

(52) U.S. Cl. CPC A61G 5/04; A61G 5/061; A61G 2203/10

(57) ABSTRACT

A patient transport apparatus including a battery system is provided. The battery system includes a battery controller configured to enable power transmission from one or more battery cells to a power output in response to power draw across the power output being below a predefined current threshold. A track assembly, a drive system including a motor disposed in rotational communication with the track assembly to control movement of the patient transport apparatus, and an apparatus controller disposed in communication with the motor and the battery system are provided. The apparatus controller is configured to monitor the power transmission from the battery and to operate the drive system in a current sink mode causing the battery to interrupt power supply upon determining the input current of the battery is greater than the predefined current threshold by comparing the input current of the battery to the predefined current threshold.

### CROSS-REFERENCE TO RELATED APPLICATION

The subject patent application claims priority to and all the benefits of U.S. Provisional Patent Application No. 63/423,646 filed on Nov. 8, 2022, the disclosure of which is hereby incorporated by reference in its entirety.

### BACKGROUND

In many instances, patients with limited mobility may have difficulty traversing stairs without assistance. In certain emergency situations, traversing stairs may be the only viable option for exiting a building. In order for a caregiver to transport a patient along stairs in a safe and controlled manner, a stair chair or evacuation chair may be utilized. Stair chairs are adapted to transport seated patients either up or down stairs, with two caregivers typically supporting, stabilizing, or otherwise carrying the stair chair with the patient supported thereon. Certain types of conventional stair chairs utilize powered tracks to facilitate traversing stairs, whereby one of the caregivers manipulates controls for the powered tracks while also supporting the stair chair. Here, motors are typically used to generate torque used to move the tracks.

With enhancements of powered stair chairs, ensuring battery safety is increasingly important to protect the battery system against overvoltage, undervoltage, charging overcurrent, and discharging overcurrent. However, redundant hardware and software are employed to disconnect the battery system which increases system complexity, weight of the powered stair chairs, costs, as well as issues in line with powered devices which include reliability reduction, thermal generation, reduced product efficiency, and reduced motor speed. Furthermore, these types of powered stair chairs can sometimes be difficult to control in a consistent and predictable fashion under various operation conditions.

Accordingly, there remains a need in the art to address one or more of the challenges outlined above.

### SUMMARY

The present disclosure provides a patient transport apparatus may include: a support structure; a battery system coupled to the support structure, the battery system including: a power output, one or more battery cells configurable for power transmission, and a battery controller in communication with one or more battery cells, the battery controller configured to enable power transmission from one or more battery cells to the power output in response to power draw across the power output being below a predefined current threshold; a track assembly having a movable belt, the track assembly being operatively attached to the support structure and arranged for selective operation between a retracted position disposed adjacent the support structure and a deployed position extending to engage stairs; an apparatus power circuit for operating one or more powered devices including a drive system including a motor disposed in rotational communication with the track assembly to control movement of the patient transport apparatus along stairs when the track assembly operates in the deployed position, the drive system operable between: a current sink mode, and an operational mode for generating rotational torque to control movement of the patient transport apparatus; and an apparatus controller disposed in communication with the motor and the battery system and configured to monitor the power transmission and to operate the drive system in the current sink mode causing the battery controller to interrupt power supply upon determining an input current of the battery system is greater than the predefined current threshold by comparing the input current of the battery system to the predefined current threshold.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a front perspective view of a patient transport apparatus according to the present disclosure, shown arranged in a chair configuration for supporting a patient for transport along a floor surface, and shown having a track assembly disposed in a retracted position, and a handle assembly disposed in a collapsed position.

FIG. 2 is another front perspective view of the patient transport apparatus of FIG. 1, shown arranged in a stair configuration for supporting the patient for transport along stairs, and shown with the track assembly disposed in a deployed position, and with the handle assembly disposed in an extended position.

FIG. 3 is a rear perspective view of the patient transport apparatus of FIGS. 1-2, shown arranged in the stair configuration as depicted in FIG. 2, and shown having an extension lock mechanism, a folding lock mechanism, and a deployment lock mechanism.

FIG. 4 is a partial schematic view of a control system of the patient transport apparatus of FIGS. 1-3, shown with a controller disposed in communication with a battery, a user interface, a drive system, and a plurality of light modules.

FIG. 5 is a right-side plan view of the patient transport apparatus of FIGS. 1-4, shown arranged in a stowed configuration maintained by the folding lock mechanism.

FIG. 6A is another right-side plan view of the patient transport apparatus of FIG. 5, shown arranged in the chair configuration as depicted in FIG. 1.

FIG. 6B is another right-side plan view of the patient transport apparatus of FIGS. 5-6A, shown arranged in the stair configuration as depicted in FIGS. 2-3.

FIG. 7A is a partial rear perspective view of the patient transport apparatus of FIGS. 1-6B, shown arranged in the chair configuration as depicted in FIGS. 1 and 6A, with the deployment lock mechanism shown retaining the track assembly in the retracted position.

FIG. 7B is another partial rear perspective view of the patient transport apparatus of FIG. 7A, shown arranged in the stair configuration as depicted in FIGS. 2-3 and 6B, with the deployment lock mechanism shown retaining the track assembly in the deployed position.

FIG. 8 is a perspective view of portions of the deployment lock mechanism of FIGS. 7A-7B, shown having a deployment lock release.

FIG. 9A is a partial section view generally taken through plane 9 of FIGS. 7B-8, shown with the deployment lock mechanism retaining the track assembly in the deployed position.

FIG. 9B is another partial section view of the portions of the patient transport apparatus depicted in FIG. 9A, shown with the track assembly having moved from the deployed position in response to engagement of the deployment lock release of the deployment lock mechanism.

FIG. 10 is a partial rear perspective view of the patient transport apparatus of FIGS. 1-9B, showing additional detail of the folding lock mechanism.

FIG. 11A is a partial schematic view of portions of the folding lock mechanism of the patient transport apparatus of FIGS. 1-10, shown arranged in a stow lock configuration corresponding to the stowed configuration as depicted in FIG. 5.

FIG. 11B is another partial schematic view of the portions of the folding lock mechanism of FIG. 11A, shown having moved out of the stow lock configuration to enable operation in the chair configuration as depicted in FIG. 6A.

FIG. 11C is another partial schematic view of the portions of the folding lock mechanism of FIGS. 10A-1B, shown arranged in a use lock configuration corresponding to the chair configuration as depicted in FIG. 6A.

FIG. 11D is another partial schematic view of the portions of the folding lock mechanism of FIGS. 10A-10C, shown having moved out of the use lock configuration to enable operation in the stowed configuration as depicted in FIG. 5.

FIG. 12A is a right-side plan view of the patient transport apparatus of FIGS. 1-10D, shown supporting a patient in the chair configuration on a floor surface adjacent to stairs, and shown with a first caregiver engaging a pivoting handle assembly.

FIG. 12B is another right-side plan view of the patient transport apparatus of FIG. 12A, shown with a second caregiver engaging a front handle assembly in an extended position.

FIG. 12C is another right-side plan view of the patient transport apparatus of FIG. 12B, shown having moved closer to the stairs.

FIG. 12D is another right-side plan view of the patient transport apparatus of FIG. 12C, shown with the first caregiver engaging the handle assembly in the extended position.

FIG. 12E is another right-side plan view of the patient transport apparatus of FIG. 12D, shown with the first caregiver having engaged the deployment lock mechanism to move the track assembly out of the retracted position.

FIG. 12F is another right-side plan view of the patient transport apparatus of FIG. 12E, shown supporting the patient in the stair configuration with the track assembly in the deployed position.

FIG. 12G is another right-side plan view of the patient transport apparatus of FIG. 12F, shown having moved towards the stairs for descent while supported by the first and second caregivers.

FIG. 12H is another right-side plan view of the patient transport apparatus of FIG. 12C, shown having moved initially down the stairs for descent to bring a belt of the track assembly into contact with the stairs while still supported by the first and second caregivers.

FIG. 12I is another right-side plan view of the patient transport apparatus of FIG. 12C, shown with the belt of the track assembly in contact with the stairs while still supported by the first and second caregivers.

FIG. 13A is a partial perspective view of a drive system of the patient transport apparatus of FIGS. 1-12I.

FIG. 13B is another partial perspective view of the drive system of FIG. 13A, shown with certain components removed.

FIG. 14 is a partial perspective view of an alternative drive system for the patient transport apparatus of FIGS. 1-12I.

FIG. 15 is an electrical diagram depicting a three-phase brushless DC motor of a drive system for the patient transport apparatus of FIG. 1-14.

FIG. 16 is a representative timing diagram depicting a battery fault event.

FIG. 17 is an exemplary flow diagram for a battery fault event according to one configuration of the present disclosure.

### DETAILED DESCRIPTION

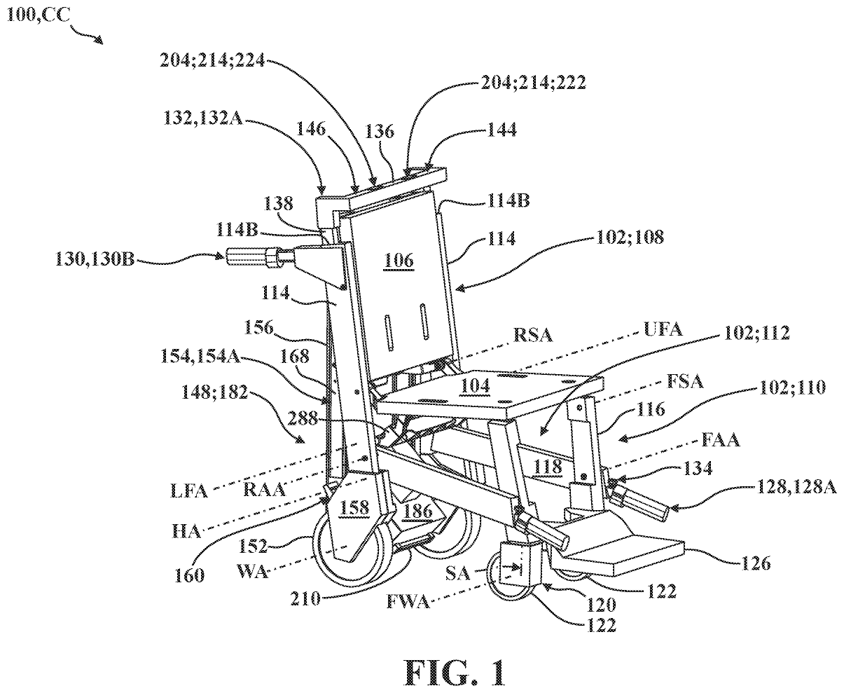

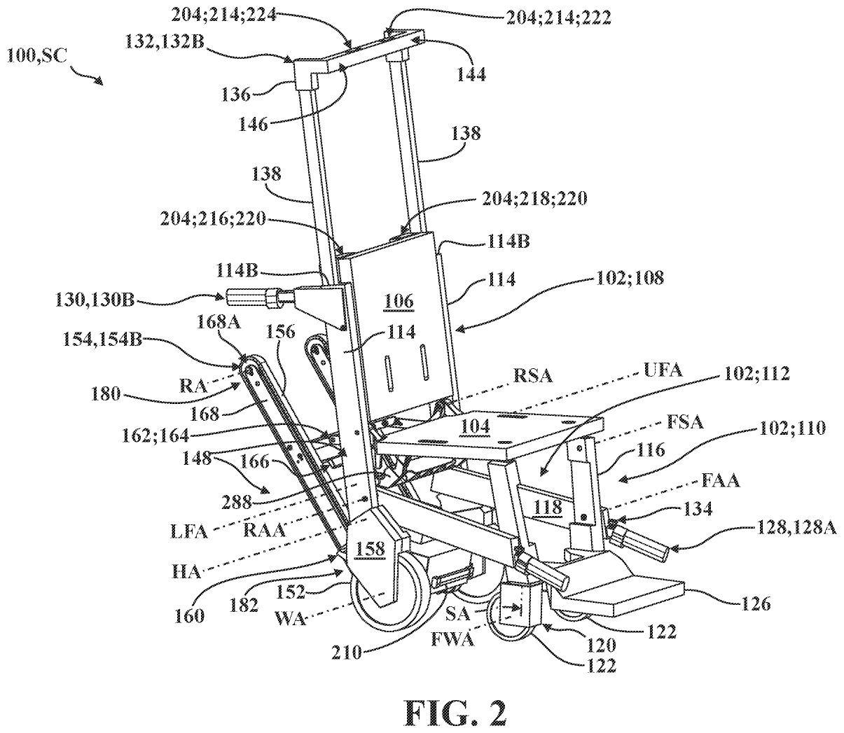

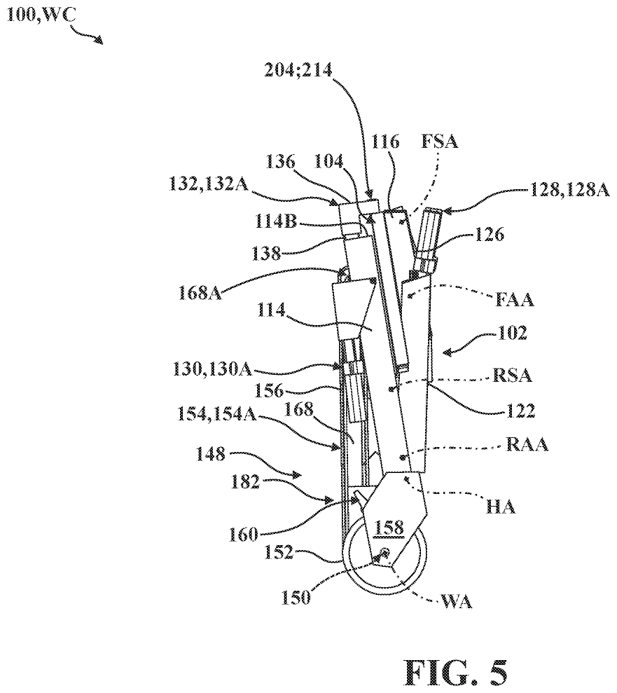

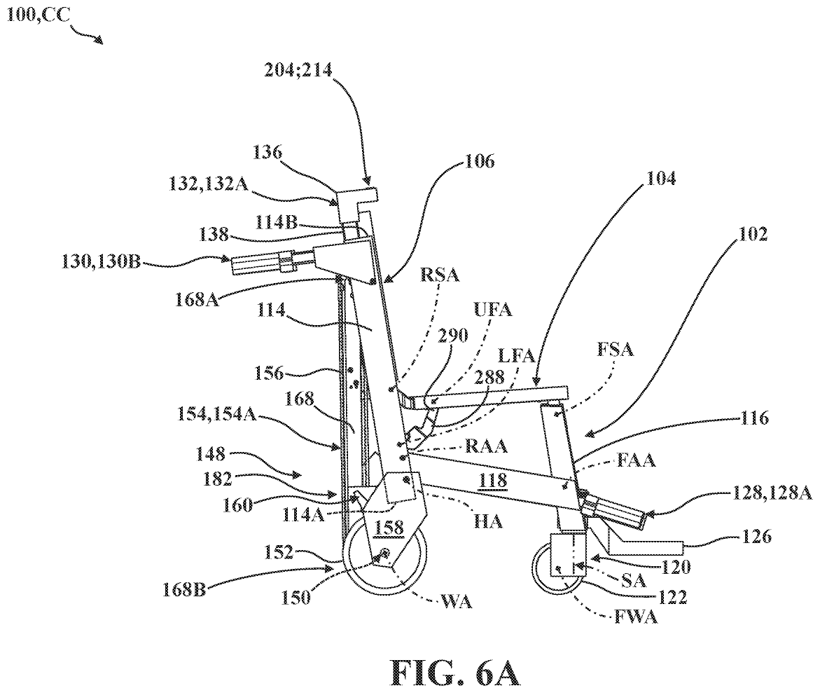

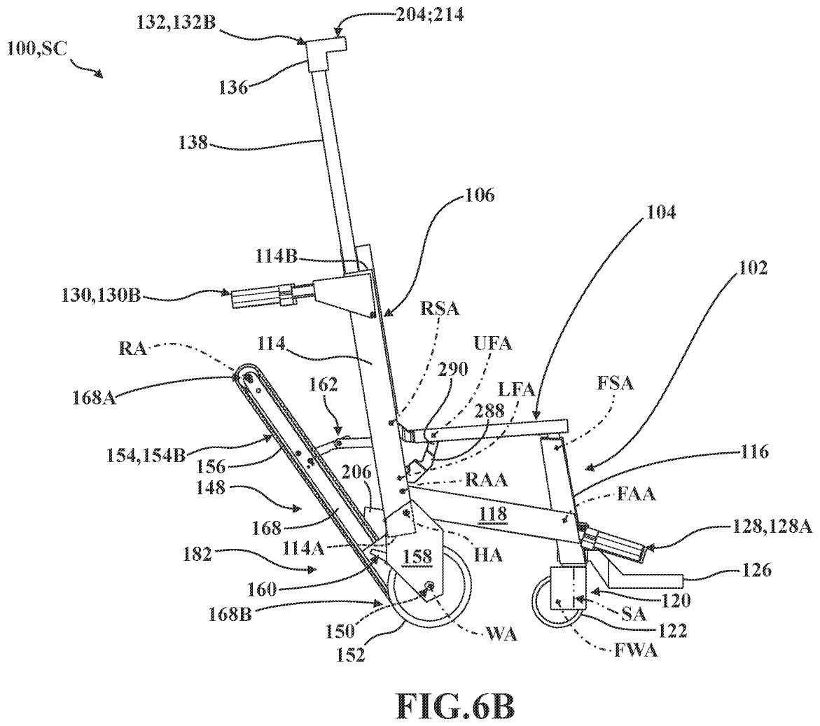

Referring now to the drawings, wherein like numerals indicate like parts throughout the several views, the present disclosure is generally directed toward a patient transport apparatus 100 configured to allow one or more caregivers to transport a patient. To this end, the patient transport apparatus 100 is realized as a “stair chair” which can be operated in a chair configuration CC (see FIGS. 1 and 6A) to transport the patient across ground or floor surfaces FS (e.g., pavement, hallways, and the like), as well as in a stair configuration SC (see FIGS. 2 and 6B) to transport the patient along stairs ST. As will be appreciated from the subsequent description below, the patient transport apparatus 100 of the present disclosure is also configured to be operable in a stowed configuration WC (see FIG. 5) when not being utilized to transport patients (e.g., for storage in an ambulance).

As is best shown in FIG. 1, the patient transport apparatus 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112 that is. The back section 106 is coupled to the rear support assembly 108 for concurrent movement. To this end, the rear support assembly 108 comprises rear uprights 114 which extend generally vertically and are secured to the back section 106 such as with fasteners (not shown in detail). The rear uprights 114 are spaced generally laterally from each other in the illustrated configurations, and are formed from separate components which cooperate to generally define the rear support assembly 108. However, those having ordinary skill in the art will appreciate that other configurations are contemplated, and the rear support assembly 108 could comprise or otherwise be defined by any suitable number of components. The front support assembly 110 comprises front struts 116 which, like the rear uprights 114, are spaced laterally from each other and extend generally vertically. The intermediate support assembly 112 comprises intermediate arms 118 which are also spaced laterally from each other. Here too, it will be appreciated that other configurations are contemplated, and the front support assembly 110 and/or the intermediate support assembly 112 could comprise or otherwise be defined by any suitable number of components.

The intermediate support assembly 112 and the seat section 104 are each pivotably coupled to the rear support assembly 108. More specifically, the seat section 104 is arranged so as to pivot about a rear seat axis RSA which extends through the rear uprights 114 (compare FIGS. 5-6A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114 (compare FIGS. 5-6A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 5-6A; pivoting about front seat axis FSA not shown in detail), and the intermediate arms 118 pivot about a front arm axis FAA which is spaced from the front seat axis FSA and extends through the front struts 116 (compare FIGS. 5-6A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration WC (see FIG. 5) and the chair configuration CC (see FIG. 6A). While the seat section 104 is generally configured to remain stationary relative to the support structure 102 when operating in the chair configuration CC or in the stair configuration CC according to the illustrated configurations, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

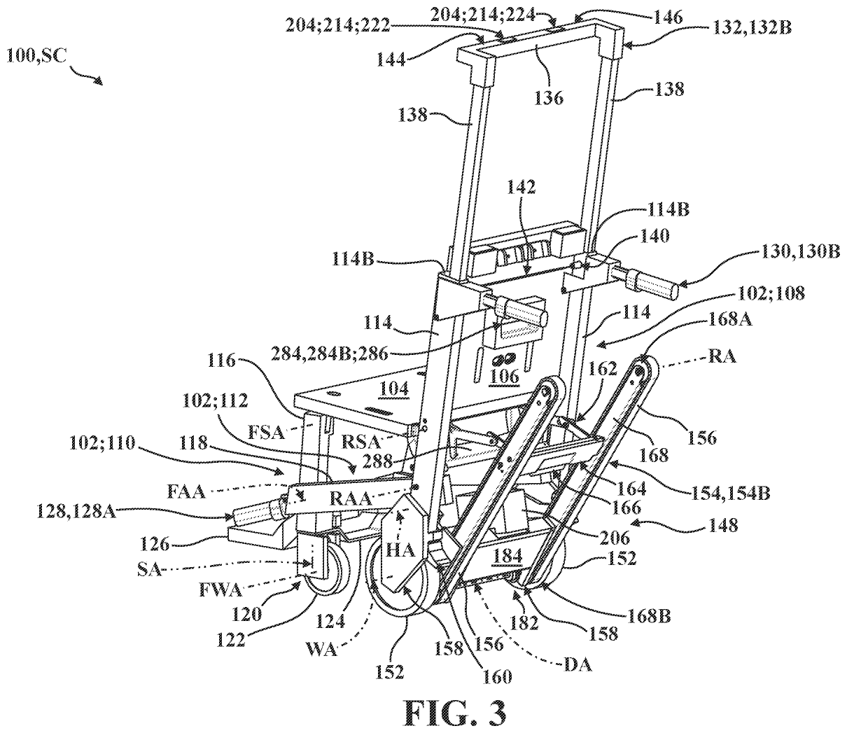

Referring now to FIGS. 1-3, the front support assembly 110 includes a pair of caster assemblies 120 which each comprise a front wheel 122 arranged to rotate about a respective front wheel axis FWA and to pivot about a respective swivel axis SA (compare FIGS. 5-6A; pivoting about swivel axis SA not shown in detail). The caster assemblies 120 are generally arranged on opposing lateral sides of the front support assembly 110 and are operatively attached to the front struts 116. A lateral brace 124 (see FIG. 3) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

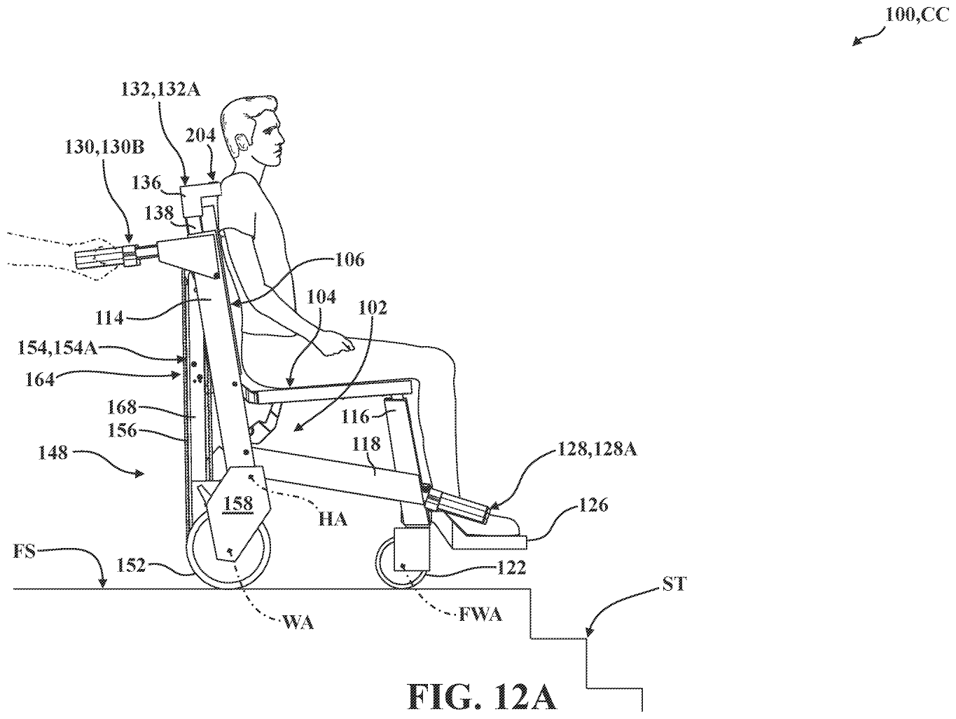

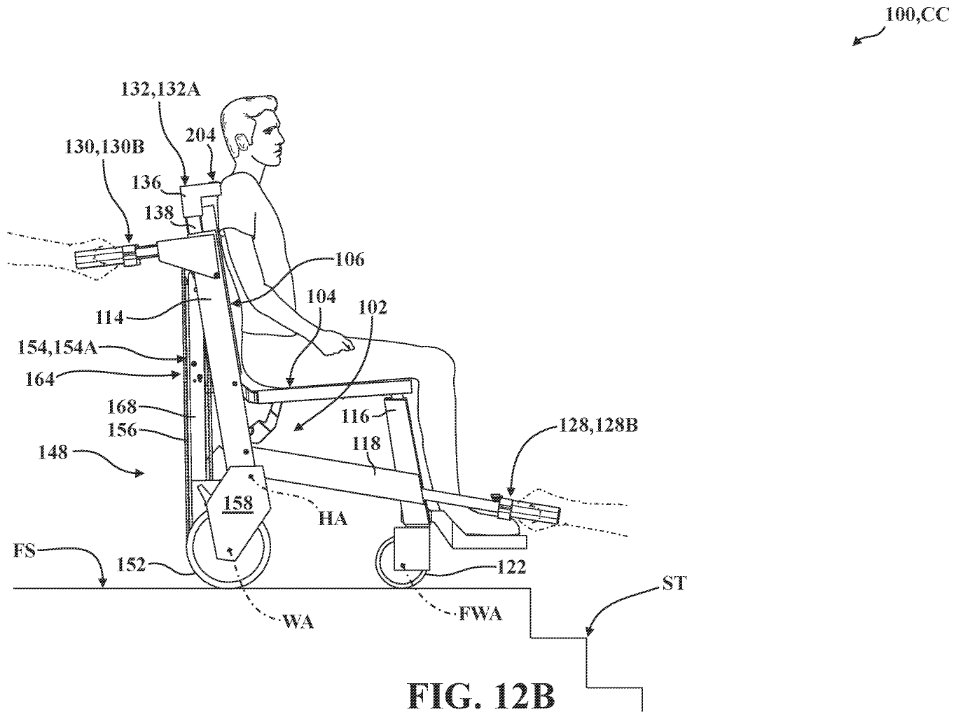

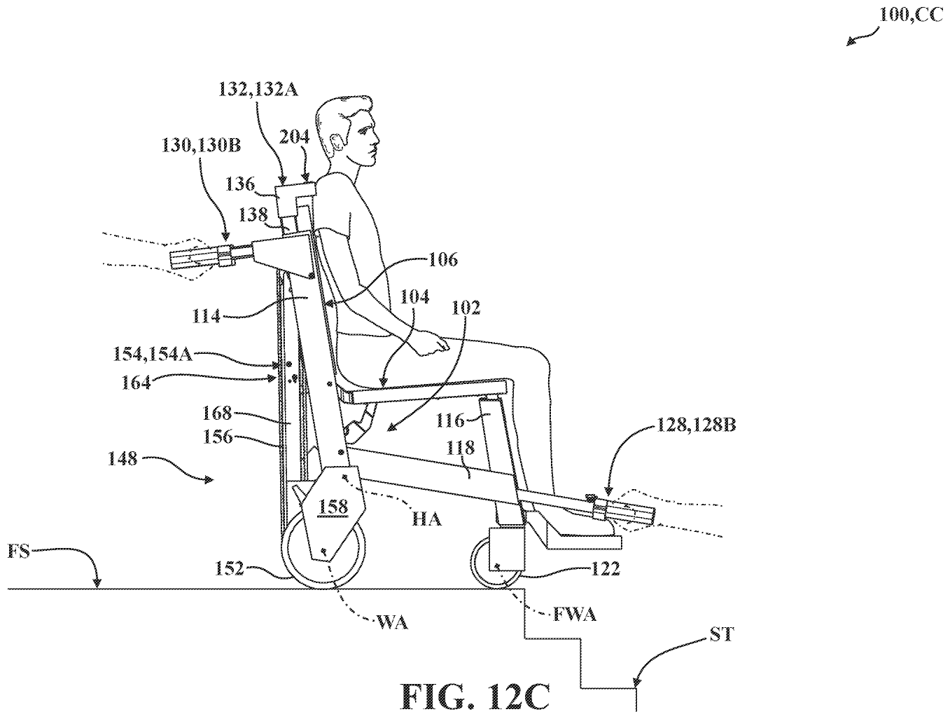

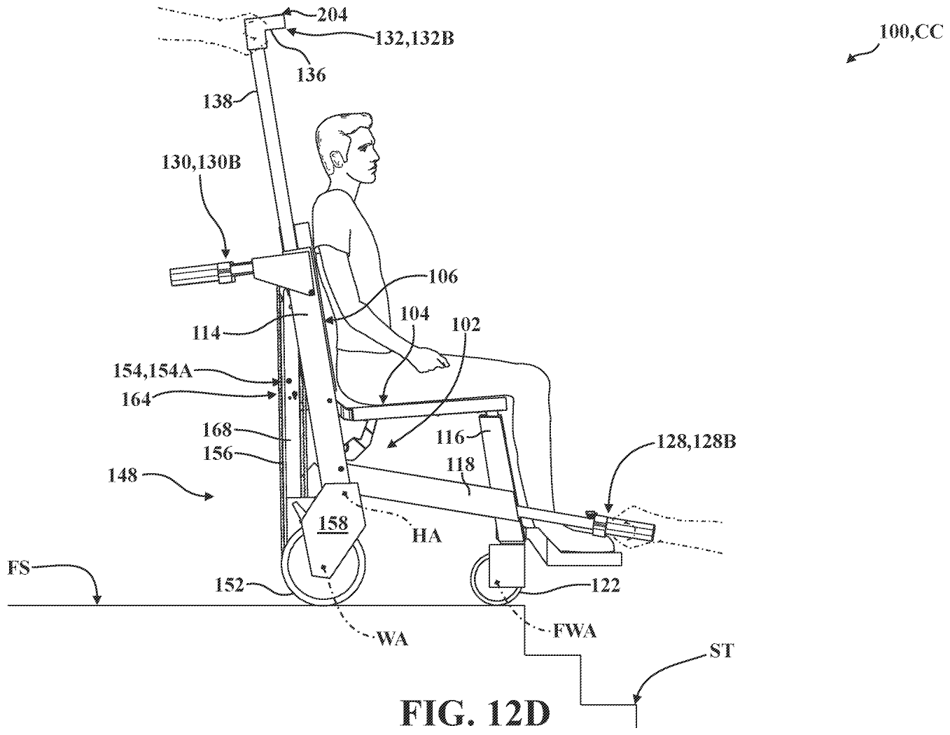

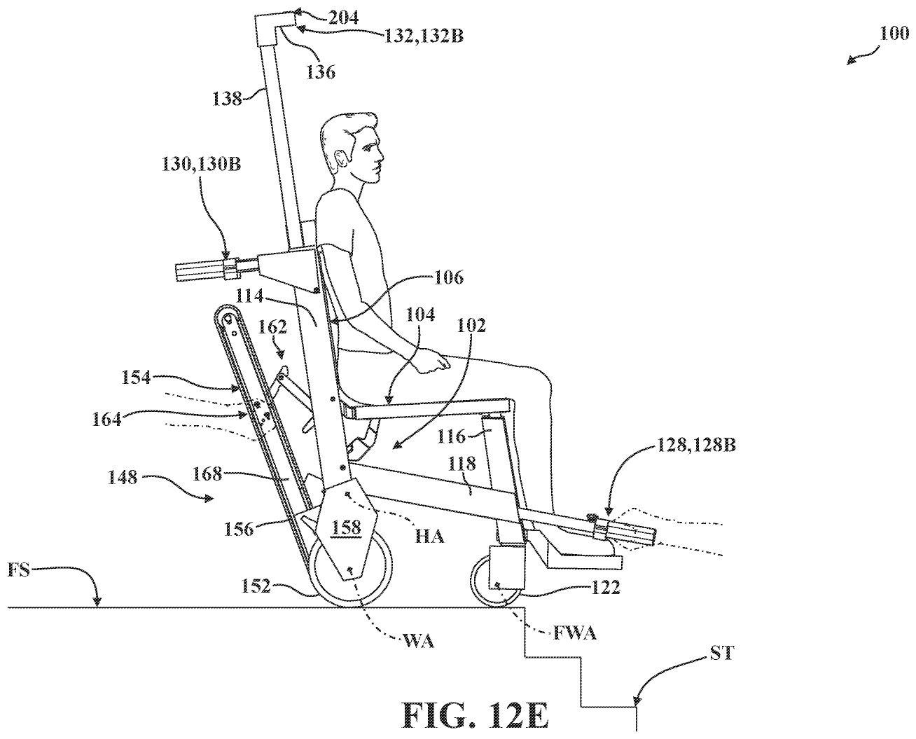

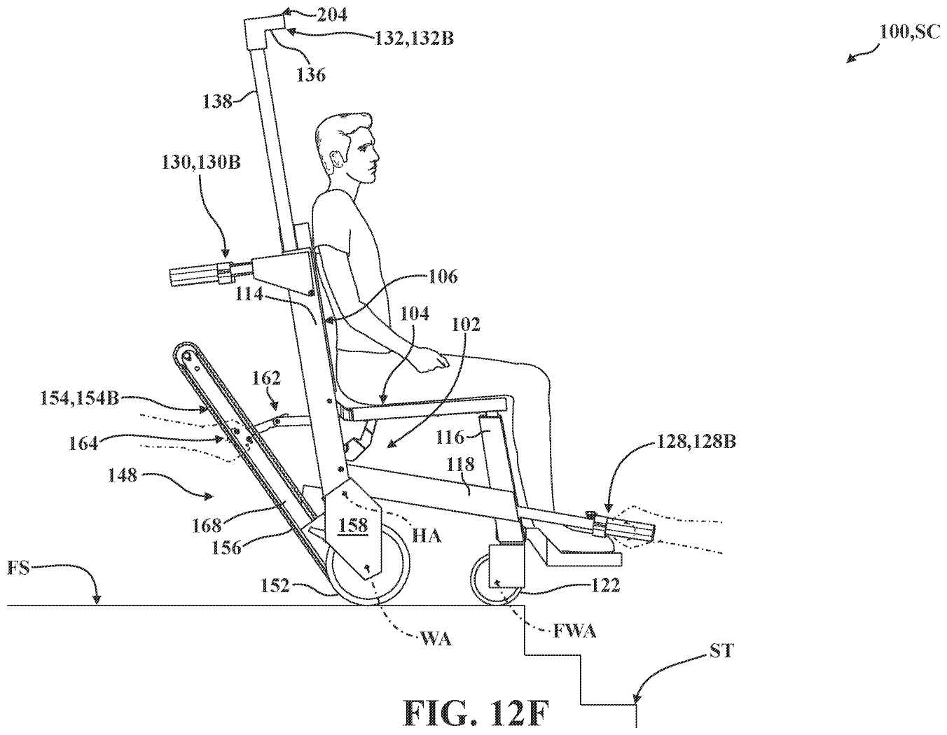

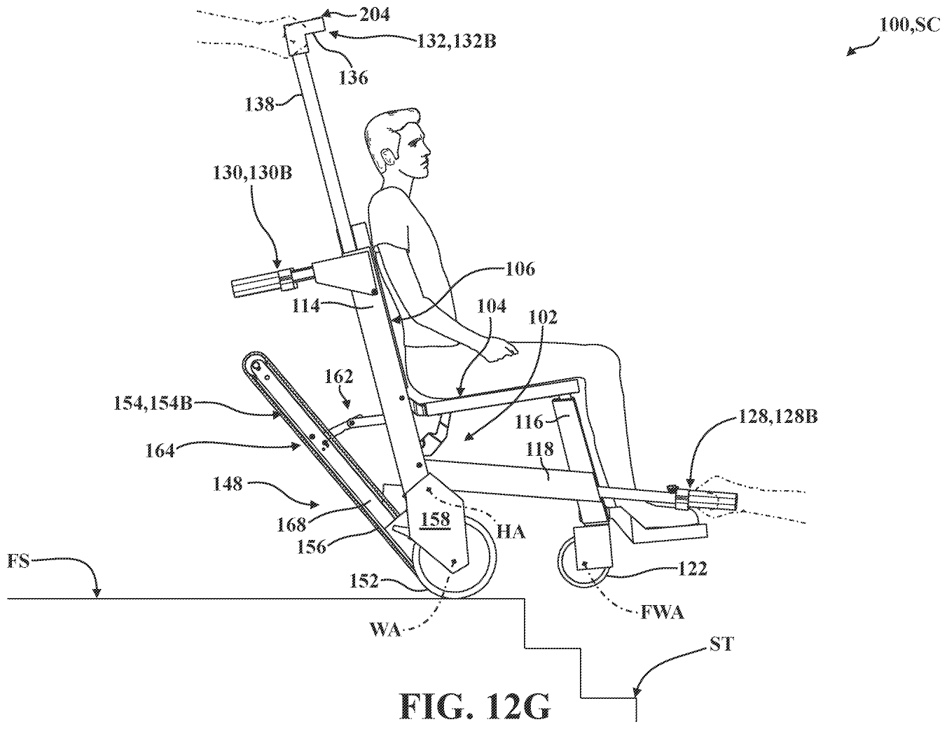

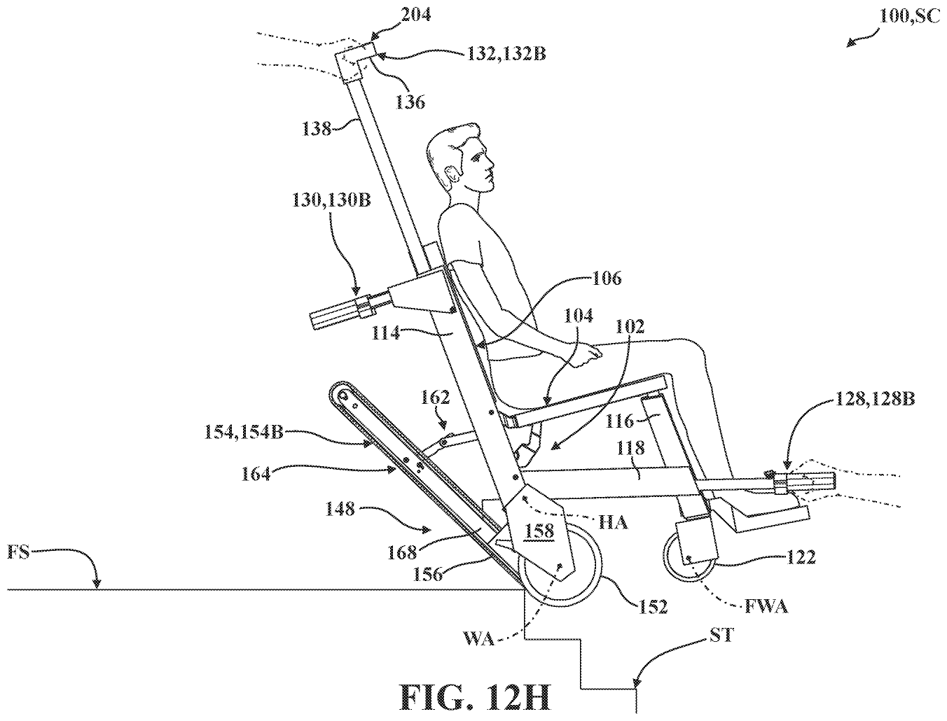

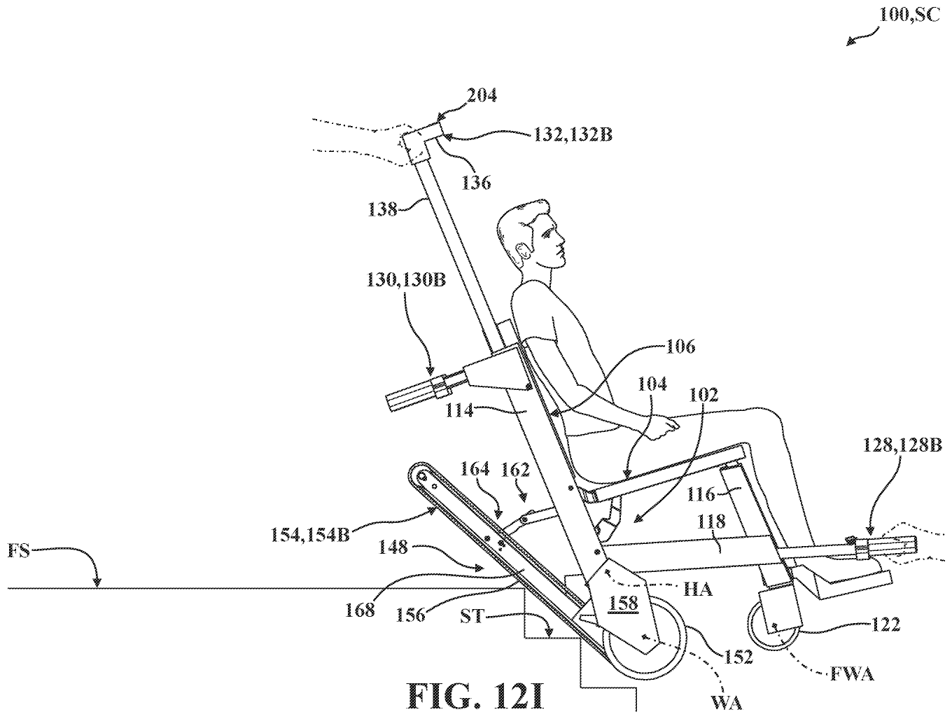

The representative configurations of the patient transport apparatus 100 illustrated throughout the drawings comprise different handles arranged for engagement by caregivers during patient transport. More specifically, the patient transport apparatus 100 comprises front handle assemblies 128, pivoting handle assemblies 130, and an upper handle assembly 132 (hereinafter referred to as “handle assembly 132), each of which will be described in greater detail below. The front handle assemblies 128 are supported within the respective intermediate arms 118 for movement between a collapsed position 128A (see FIG. 12A) and an extended position 128B (see FIG. 12B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 1). Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport apparatus 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport apparatus 100. In some configurations, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114 of the rear support assembly 108, and are movable relative to the rear uprights 114 between a stowed position 130A (see FIG. 5) and an engagement position 130B (see FIG. 6A). Like the front handle assemblies 128, the pivoting handle assemblies 130 are generally arranged for engagement by a caregiver during patient transport, and may advantageously be utilized in the engagement position 130B when the patient transport apparatus 100 operates in the chair configuration CC to transport the patient along floor surfaces FS. In some configurations, the pivoting handle assemblies 130 could be configured similar to as is disclosed in U.S. Pat. No. 6,648,343, previously referenced. Other configurations are contemplated.

The handle assembly 132 is also coupled to the rear support assembly 108, and generally comprises an upper grip 136 operatively attached to extension posts 138 which are supported within the respective rear uprights 114 for movement between a collapsed position 132A (see FIGS. 1 and 12C) and an extended position 132B (see FIGS. 2 and 12D). To this end, the extension posts 138 of the handle assembly 132 may be slidably supported by bushings, bearings, and the like (not shown) coupled to the rear uprights 114, and may be lockable in and/or between the collapsed position 132A and the extended position 132B via an extension lock mechanism 140 with an extension lock release 142 arranged for engagement by the caregiver. As is best shown in FIG. 3, the extension lock release 142 may be realized as a flexible connector which extends generally laterally between the rear uprights 114, and supports a cable connected to extension lock mechanisms 140 which releasably engage the extension posts 138 to maintain the handle assembly 132 in the extended position 132B and the collapsed position 132A (not shown in detail). Here, it will be appreciated that the extension lock mechanism 140 and/or the extension lock release 142 could be of a number of different styles, types, configurations, and the like sufficient to facilitate selectively locking the handle assembly 132 in the extended position 132B. In some configurations, the handle assembly 132, the extension lock mechanism 140, and/or the extension lock release 142 could be configured similar to as is disclosed in U.S. Pat. No. 6,648,343, previously referenced. Other configurations are contemplated.

In the representative version illustrated herein, the upper grip 136 generally comprises a first hand grip region 144 arranged adjacent to one of the extension posts 138, and a second hand grip region 146 arranged adjacent to the other of the extension posts 138, each of which may be engaged by the caregiver to support the patient transport apparatus 100 for movement, such as during patient transport up or down stairs ST (see FIGS. 12G-12I).

As noted above, the patient transport apparatus 100 is configured for use int transporting the patient across floor surfaces FS, such as when operating in the stair configuration SC, and for transporting the patient along stairs ST when operating in the stair configuration SC. To these ends, the illustrated patient transport apparatus 100 includes a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a movable belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIGS. 1 and 6A) to the stair configuration SC (see FIGS. 2 and 6B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 12A-12I, the movement of the rear wheels 152 relative to the front wheels 122 when transitioning from the chair configuration CC to the stair configuration SC that is afforded by the patient transport apparatus 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport apparatus 100 is “tilted” backwards about the rear wheels 152 (compare FIGS. 12D-12H). Put differently, positioning the rear wheels 152 relative to the front wheels 122 consistent with the present disclosure makes “tilting” the patient transport apparatus 100 significantly less burdensome for the caregivers and, at the same time, much more comfortable for the patient due to the arrangement of the patient's center of gravity relative to the portion of the rear wheels 152 contacting the floor surface FS as the patient transport apparatus 100 is “tilted” backwards to transition into engagement with the stairs ST.

In the representative configurations illustrated herein, the carrier assembly 148 comprises hubs 158 that are pivotably coupled to the respective rear uprights 114 for concurrent movement about the hub axis HA. Here, one or more bearings, bushings, shafts, fasteners, and the like (not shown in detail) may be provided to facilitate pivoting motion of the hubs 158 relative to the rear uprights 114. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport apparatus 100 illustrated herein employs hubs 158 with “mirrored” profiles that are coupled to the respective rear uprights 114 and support discrete shafts 150 and wheel locks 160, it will be appreciated that a single hub 158 and/or a single shaft 150 could be employed. Other configurations are contemplated.

As is best depicted in FIGS. 6A-6B, the rear uprights 114 each generally extend between a lower upright end 114A and an upper upright end 114B, with the hub axis HA arranged adjacent to the lower upright end 114A. The lower upright end 114A is supported for movement within the hub 158, which may comprise a hollow profile or recess defined by multiple hub housing components (not shown in detail in FIGS. 6A-6B). The rear uprights 114 may each comprise a generally hollow, extruded profile which supports various components of the patient transport apparatus 100. In the illustrated version, the hub axis HA is arranged generally vertically between the rear arm axis RAA and the wheel axis WA.

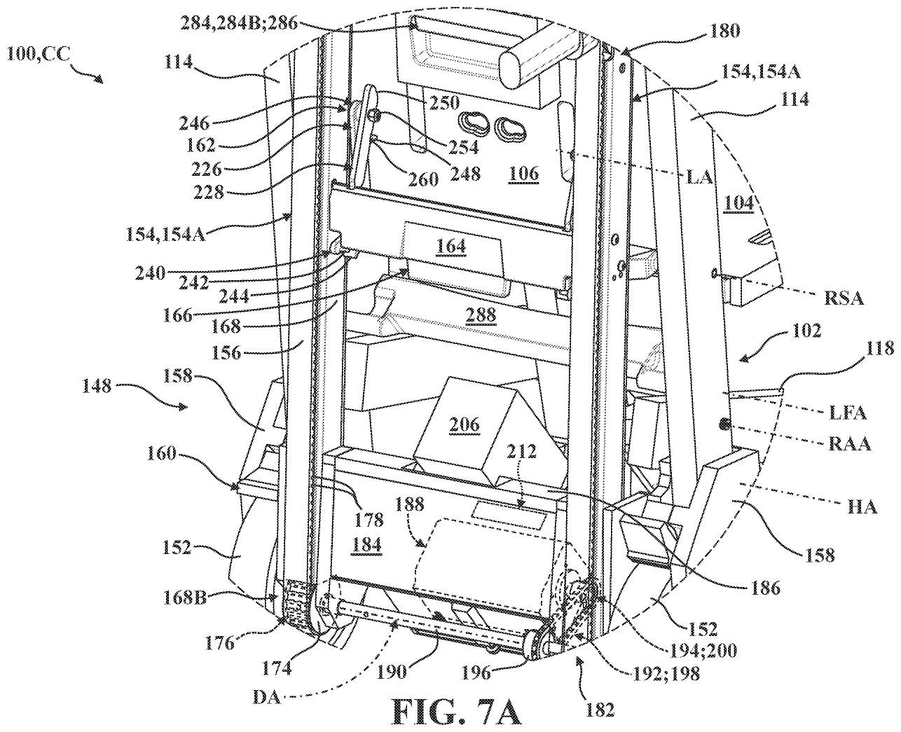

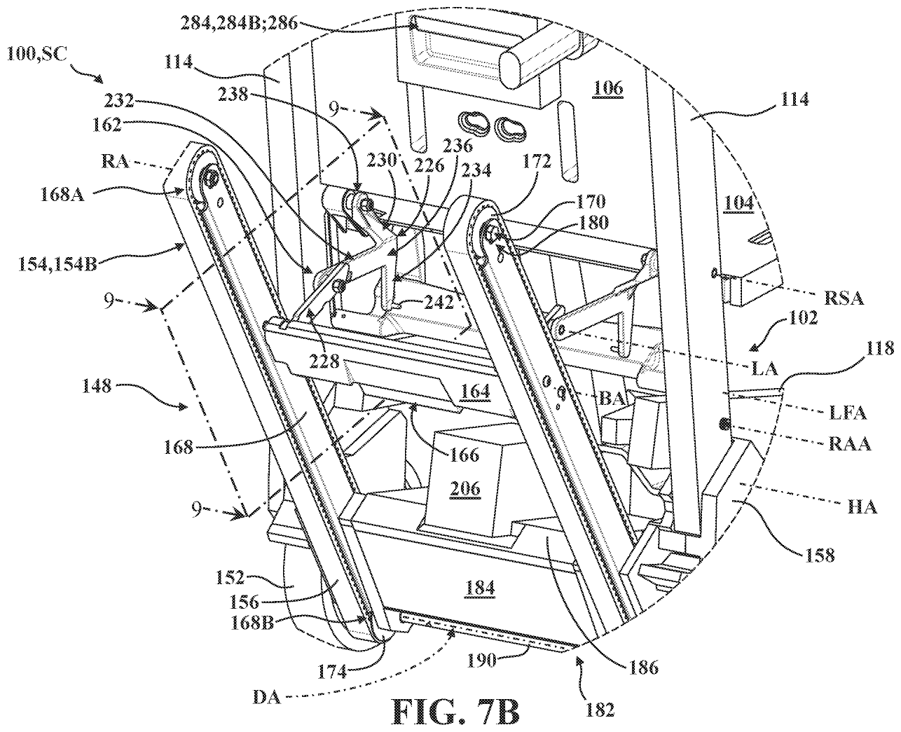

Referring now to FIGS. 7A-7B, as noted above, the track assemblies 154 move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport apparatus 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

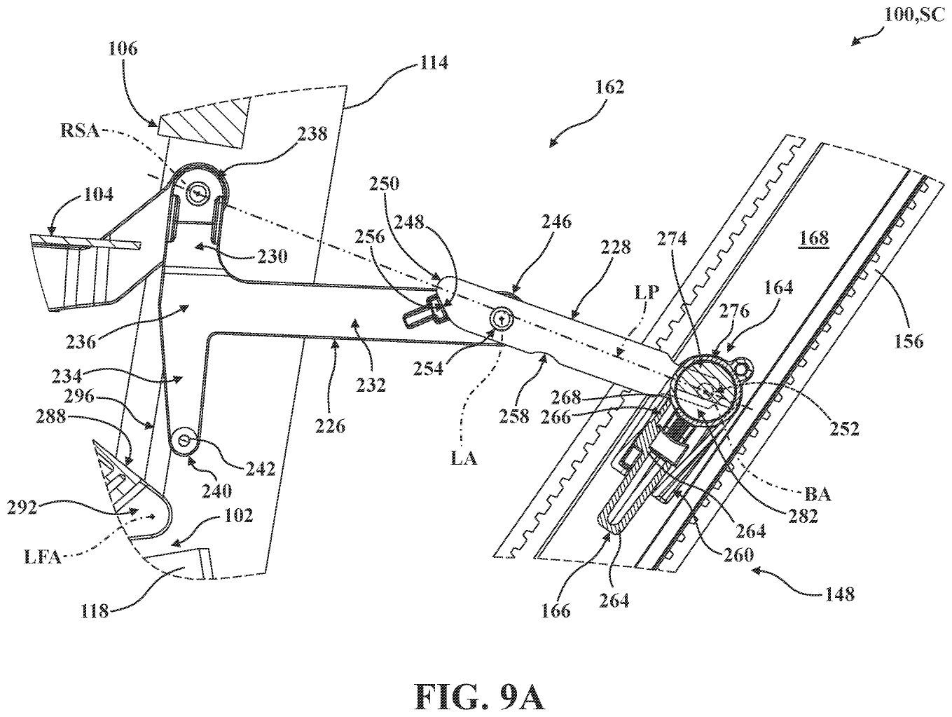

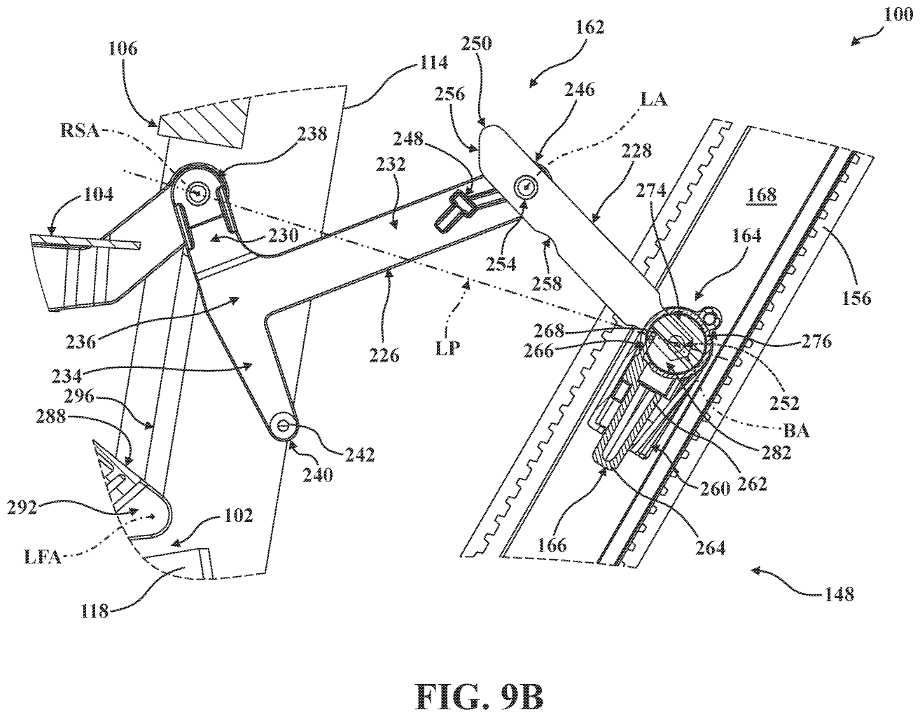

In the illustrated version, the patient transport apparatus 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each rail 168, and a roller 172 is supported for rotation about the roller axis RA (compare FIGS. 9A-9B). For each of the track assemblies 154, the belt 156 is disposed in engagement with the roller 172 and is arranged for movement relative to the rail 168 in response to rotation of the roller 172 about the roller axis RA. Adjacent to the second rail end 168B of each rail 168, a drive pulley 174 is supported for rotation about a drive axis DA and is likewise disposed in engagement with the belt 156 (see FIGS. 7A-7B; rotation about drive axis DA not shown in detail). Here, the drive pulley 174 comprises outer teeth 176 which are disposed in engagement with inner teeth 178 formed on the belt 156. The track assemblies 154 each also comprise a belt tensioner, generally indicated at 180, configured to adjust tension in the belt 156 between the roller 172 and the drive pulley 174.

In the representative version illustrated herein, the patient transport apparatus 100 comprises a drive system, generally indicated at 182, configured to facilitate driving the belts 156 of the track assemblies 154 relative to the rails 168 to facilitate movement of the patient transport apparatus 100 up and down stairs ST. To this end, and as is depicted in FIG. 7A, the drive system 182 comprises a drive frame 184 and a cover 186 which are operatively attached to the hubs 158 of the carrier assembly 148 for concurrent movement with the track assemblies 154 between the retracted position 154A and the deployed position 154B. As will be discussed in greater detail below, the drive system 182 is operable between a current sink mode MC and an operational mode MO for generating rotational torque to control movement of the patient transport apparatus 100.

A motor 188 (depicted in phantom in FIG. 7A) is coupled to the drive frame 184 and is concealed by the cover 186. The motor 188 is disposed in rotational communication with the track assembly 154 to control movement of the patient transport apparatus 1000 along stairs when the track assembly 154 operates in a deployed position 154B. The motor 188 is configured to selectively generate rotational torque used to drive the belts 156 via the drive pulleys 174, as described in greater detail below. To this end, a drive axle 190 is coupled to each of the drive pulleys 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 7A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation geartrains 192 which comprise various arrangements of gears, planetary gearsets, and the like.

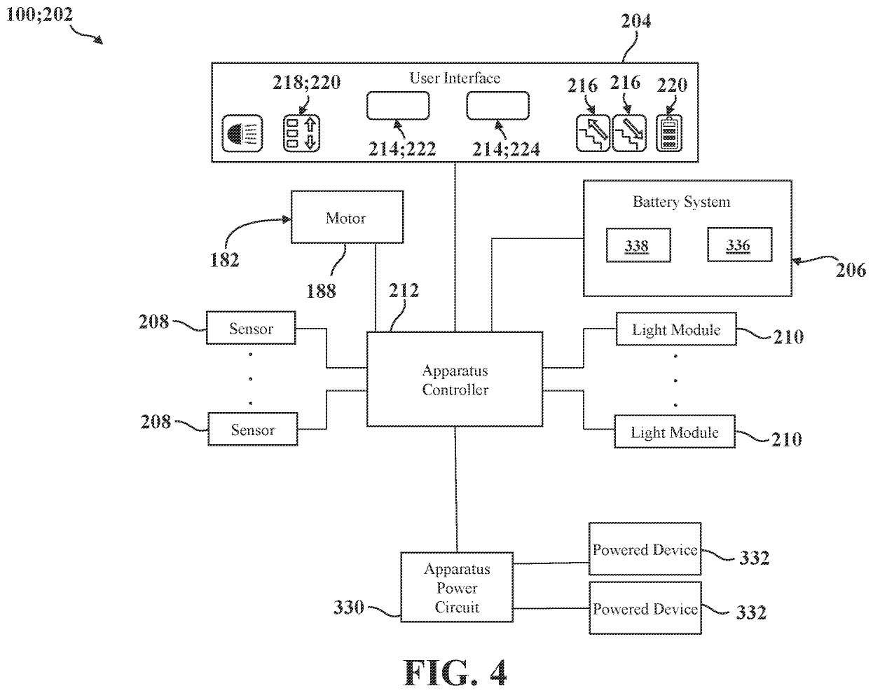

The patient transport apparatus 100 comprises a control system 202 to, among other things, facilitate control of the track assemblies 154. To this end, and as is depicted schematically in FIG. 4, the representative version of the control system 202 generally comprises a user interface 204, a battery system 206, one or more sensors 208, and one or more light modules 210 which are disposed in electrical communication with an apparatus controller 212. The one or more sensors 208 and one or more light modules 210 may be considered as any auxiliary load 500 to the patient transport apparatus 100. The battery system 206 will be discussed in greater detail below. As will be appreciated from the subsequent description below, the apparatus controller 212 may be of a number of different types, styles, and/or configurations, and may employ one or more microprocessors for processing instructions or an algorithm stored in memory to control operation of the motor 188, the light modules 210, and the like. Additionally or alternatively, the apparatus controller 212 may comprise one or more sub-controllers, microcontrollers, field programmable gate arrays, systems on a chip, discrete circuitry, and/or other suitable hardware, software, and/or firmware that is capable of carrying out the functions described herein. The apparatus controller 212 is coupled to various electrical components of the patient transport apparatus 100 (e.g., the motor 188) in a manner that allows the apparatus controller 212 to control or otherwise interact with those electrical components the (e.g., via wired and/or wireless electrical communication). In some configurations, the apparatus controller 212 may generate and transmit control signals to the one or more powered devices 332, or components thereof, to drive or otherwise facilitate operating those powered devices 332, or to cause the one or more powered devices 332 to perform one or more of their respective functions. In some configurations, an apparatus power circuit 330 is provided for operating the one or more powered devices 332.

The apparatus controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport apparatus 100. Other types of sensors 208 are also contemplated. Some of the sensors 208 may monitor thresholds movement relative to discrete reference points. The sensors 208 can be located anywhere on the patient transport apparatus 100, or remote from the patient transport apparatus 100. Other configurations are contemplated.

It will be appreciated that the patient transport apparatus 100 may employ light modules 210 to, among other things, illuminate the user interface 204, direct light toward the floor surface FS, and the like. It will be appreciated that the light modules 210 can be of a number of different types, styles, configurations, and the like (e.g., light emitting diodes LEDs) without departing from the scope of the present disclosure. Similarly, it will be appreciated that the user interface 204 may employ user input controls of a number of different types, styles, configurations, and the like (e.g., capacitive touch sensors, switches, buttons, and the like) without departing from the scope of the present disclosure.

The battery system 206 provides power to the apparatus controller 212, the motor 188, the light modules 210, and other components of the patient transport apparatus 100 during use, and is removably attachable to the cover 186 of the drive system 182 in the illustrated version (see FIG. 7A; attachment not shown in detail). The user interface 204 is generally configured to facilitate controlling the drive direction and drive speed of the motor 188 to move the belts 156 of the track assembly 154 and, thus, allow the patient transport apparatus 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

The activation input controls 214 may be arranged in various locations about the patient transport apparatus. In the illustrated configurations, a first activation input control 222 is disposed adjacent to the first hand grip region 144 of the handle assembly 132, and a second activation input control 224 is disposed adjacent to the second hand grip region 146. In the illustrated version, the user interface 204 is configured such that the caregiver can engage either of the activation input controls 222, 224 with a single hand grasping the upper grip 136 of the handle assembly 132 during use.

In the illustrated configurations, the patient transport apparatus 100 is configured to limit movement of the belts 156 relative to the rails 168 during transport along stairs ST in an absence of engagement with the activation input controls 214 by the caregiver. Put differently, one or more of the apparatus controller 212, the motor 188, the geartrain 192, and/or the track assemblies 154 may be configured to “brake” or otherwise prevent movement of the belts 156 unless the activation input controls 214 are engaged, such as during operation in one or more operational modes MO. Here too, the motor 188 may be controlled via the apparatus controller 212 to prevent rotation (e.g., driving with a 0% pulse-width modulation PWM signal) in some configurations. However, other configurations are contemplated, and the patient transport apparatus 100 could be configured to prevent movement of the belts 156 in other ways. By way of non-limiting example, a mechanical brake system (not shown) could be employed in some configurations.

Referring now to FIGS. 7A-9B, the patient transport apparatus 100 employs the deployment lock mechanism 164 to releasably secure the track assembly 154 in the retracted position 154A and in the deployed position 154B. As is described in greater detail below, the deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

As is best shown in FIG. 9A, the connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114 about the rear seat axis RSA, such as by one or more fasteners, bushings, bearings, and the like (not shown in detail). Here, because the rear uprights 114 are spaced laterally away from each other at a distance large enough to allow the track assemblies 154 to “nest” therebetween in the retracted position 154A (see FIG. 7A), the forward pivot regions 230 of the connecting links 226 extend at an angle away from the rear uprights 114 at least partially laterally towards the track assemblies 154. The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 7A) as described in greater detail below. The connecting pivot regions 232 extend longitudinally away from the interface regions 236 to rearward pivot mounts 246 which pivotably couple to the brace links 228 about a link axis LA. The connecting pivot regions 232 also comprise link stops 248 that are shaped and arranged to abut the brace links 228 in the deployed position 154B (see FIG. 7B), as described in greater detail below. The connecting links 226 are each formed as separate components with mirrored profiles in the illustrated configurations, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA, as described in greater detail below. The brace links 228 each define a link abutment surface 256 disposed adjacent to the abutment link end 250 which are arranged to abut the link stops 248 of the connecting links 226 in the deployed position 154B (see FIGS. 7B and 9B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail).

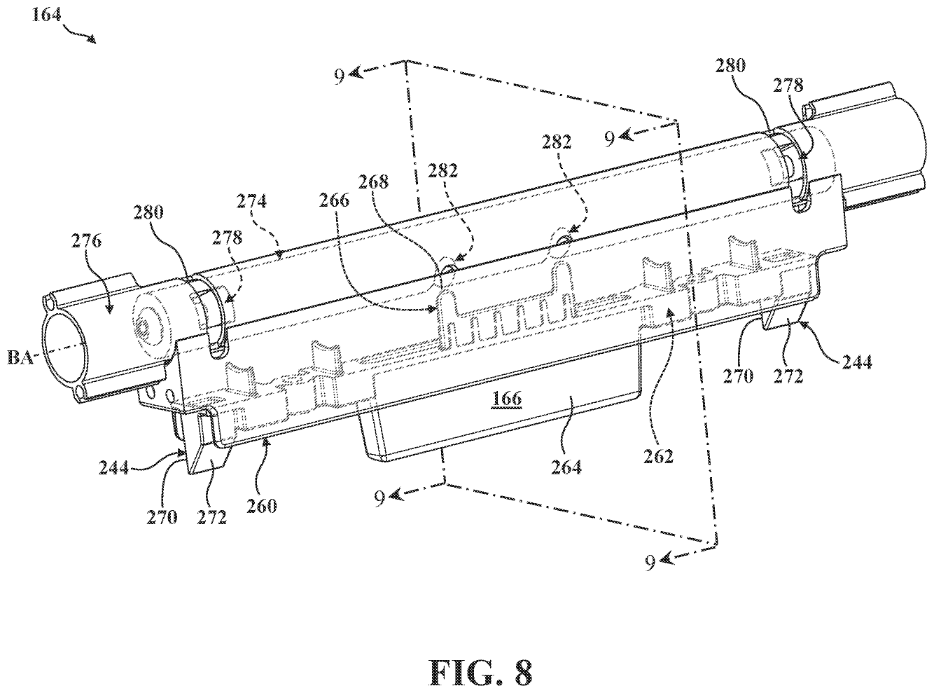

Referring now to FIG. 8, the deployment lock release 166 of the deployment lock mechanism 164 is supported for movement within a lock housing 260 which, in turn, is coupled to and extends laterally between the rails 168 of the track assemblies 154 (e.g., secured via fasteners; not shown). The deployment lock release 166 is formed as a unitary component in the illustrated version, and generally comprises a deployment body 262, a deployment button 264, one or more push tabs 266, and the trunnion catches 244. The deployment button 264 is arranged for engagement by the caregiver, extends vertically downwardly from the deployment body 262, and is disposed laterally between the trunnion catches 244. The one or more push tabs 266 extend vertically upwardly from the deployment body 262 to respective push tab ends 268, and are employed to facilitate releasing the track assemblies 154 from the deployed position 154B as described in greater detail below. The trunnion catches 244 each define a retention face 270 arranged to abut the trunnions 242 of the connecting links 226 when the track assemblies 154 are in the retracted position 154A (see FIG. 7A). The trunnion catches 244 also each define a trunnion cam face 272 arranged to engage against the trunnions 242 of the connecting links 226 as the track assemblies 154 are brought toward the deployed position 154B from the retracted position 154A. While not shown in detail throughout the drawings, engagement of the trunnions 242 against the trunnion cam faces 272 urges the deployment body 262 vertically upwardly within the lock housing 260 until the trunnions 242 come out of engagement with the trunnion cam faces 272. Here, one or more biasing elements (not shown) may bias the deployment lock release 166 vertically downwardly within the lock housing 260 such that disengagement of the trunnions 242 with trunnion cam faces 272 occurs as the track assemblies 154 reach the deployed position 154B and the trunnions 242 come into engagement with the retention faces 270 (see FIG. 7B).

With continued reference to FIG. 8, the deployment lock mechanism 164 also comprises a barrel 274 supported for rotation about the barrel axis BA (compare FIGS. 9A-9B) within a cylinder housing 276 which, in turn, is coupled to and extends laterally between the rails 168 of the track assemblies 154 (e.g., secured via fasteners; not shown). The barrel 274 defines barrel notches 278 which receive the rearward link mounts 252 of the brace links 228 therein. Here, the cylinder housing 276 comprises transverse apertures 280 aligned laterally with the barrel notches 278 and shaped to receive the brace links 228 therethrough to permit the brace links 228 to move generally concurrently with the barrel 274 relative to the cylinder housing 276. Here, the barrel notches 278 and the rearward link mounts 252 are provided with complimentary profiles that allow the brace links 228 to pivot about the barrel axis BA as the barrel 274 rotates within the cylinder housing 276. The barrel notches 278 may be sized slightly larger than the rearward link mounts 252 to prevent binding. However, it will be appreciated that other configurations are contemplated. The barrel 274 also comprises push notches 282 arranged laterally between the barrel notches 278. The push notches 282 are shaped to receive the push tab ends 268 of the push tabs 266 to facilitate releasing the track assemblies 154 from the deployed position 154B in response to the caregiver engaging the deployment button 264. As depicted in FIG. 9A, retention of the track assemblies 154 in the deployed position 154B is achieved based on the geometry of the deployment linkage 162 acting as an “over center” lock.

More specifically, when the track assemblies 154 move to the deployed position 154B, the link axis LA is arranged below a linkage plane LP defined extending through the rear seat axis RSA and the barrel axis BA, and will remain in the deployed position 154B until the link axis LA is moved above the linkage plane LP (see FIG. 9B). To this end, the caregiver can engage the deployment button 264 to bring the push tab ends 268 of the push tabs 266 into engagement with the push notches 282 formed in the barrel 274 which, in turn, rotates the barrel 274 about the barrel axis BA and pivots the brace links 228 about the barrel axis BA to cause the link axis LA to move above the linkage plane LP as shown in FIG. 9B. It will be appreciated that the deployment lock mechanism 164 could be configured in other ways sufficient to releasably lock the track assemblies 154 in the retracted position 154A and the deployed position 154B, and it is contemplated that one lock mechanism could lock the track assemblies 154 in the retracted position 154A while a different lock mechanism could lock the track assemblies 154 in the deployed position 154B. Other configurations are contemplated.

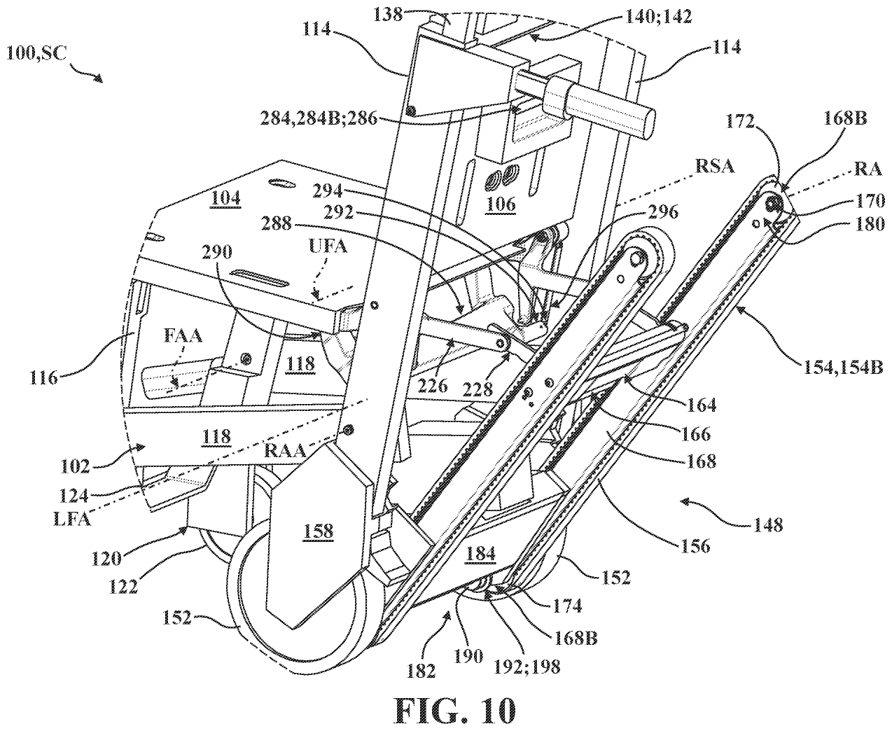

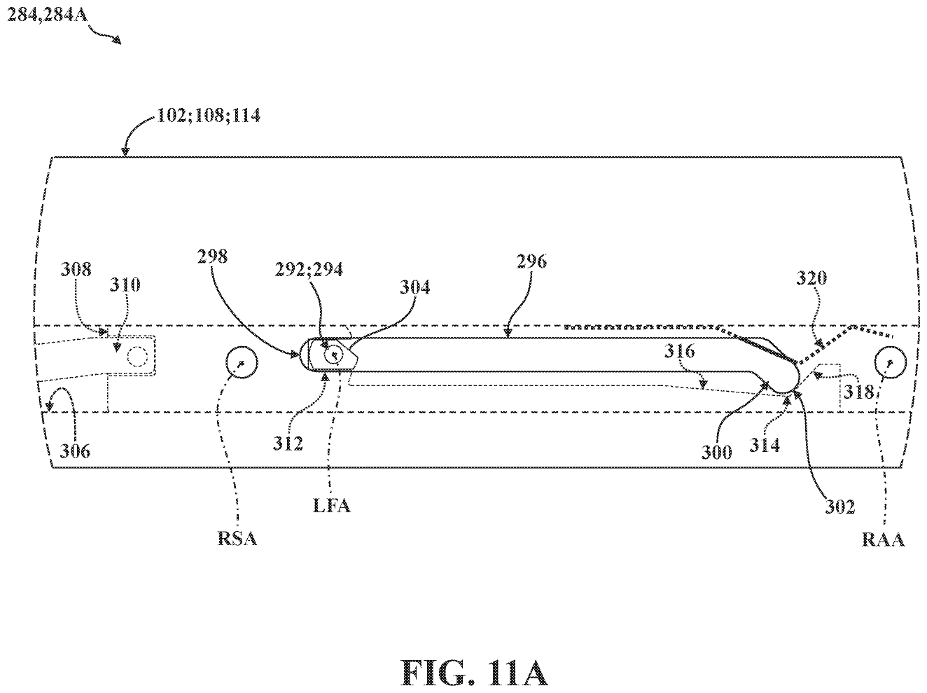

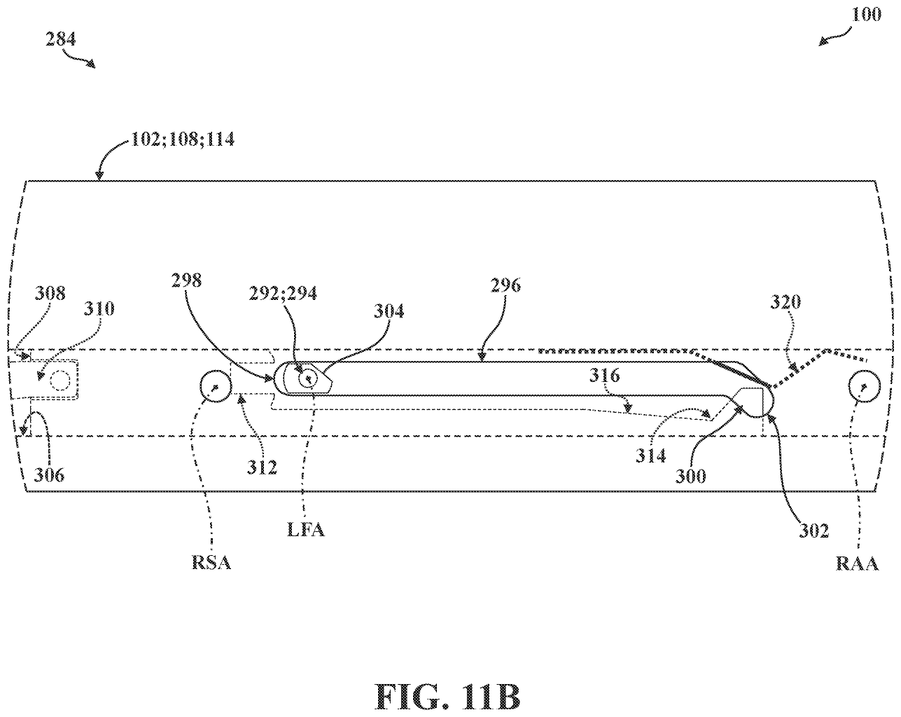

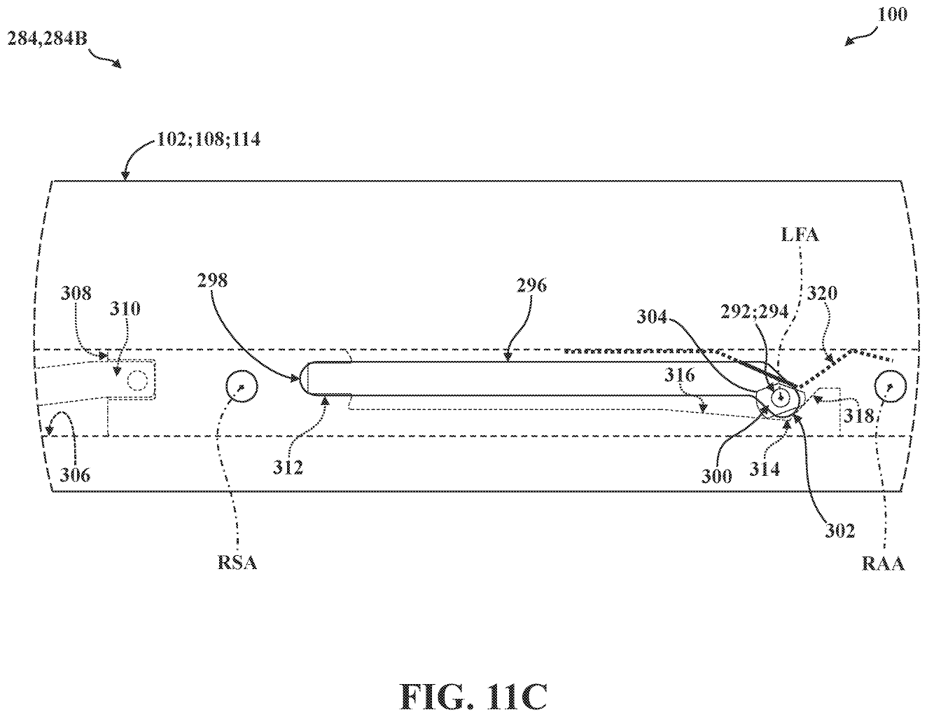

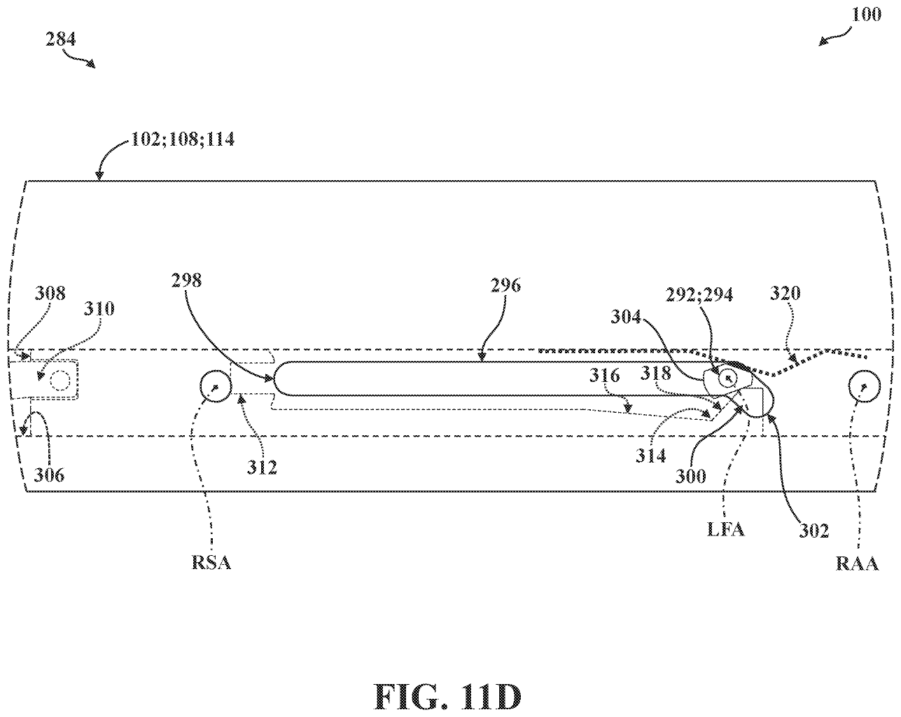

Referring now to FIGS. 10-11D, the patient transport apparatus 100 employs a folding lock mechanism 284 to facilitate changing between the stowed configuration WC (see FIG. 5) and the chair configuration CC (see FIG. 6A). To this end, the folding lock mechanism 284 generally comprises a folding lock release 286 (see FIG. 10) operatively attached to the back section 106 and arranged for engagement by the caregiver to releasably secure the folding lock mechanism 284 between a stow lock configuration 284A to maintain the stowed configuration WC, and a use lock configuration 284B to prevent movement to the stowed configuration WC from the chair configuration CC or from the stair configuration SC. To this end, the folding lock mechanism 284 generally comprises a folding link 288 with folding pivot mounts 290 and sliding pivot mounts 292. The folding pivot mounts 290 are pivotably coupled to the seat section 104 about an upper folding axis UFA that is arranged between the rear seat axis RSA and the front seat axis FSA (see FIGS. 2 and 6A-6B; pivoting not shown in detail). The sliding pivot mounts 292 each comprise a keeper shaft 294 which extends along a lower folding axis LFA which is arranged substantially parallel to the upper folding axis UFA. The keeper shafts 294 are disposed within and slide along slots 296 formed in each of the rear uprights 114. For the illustrative purposes, the keeper shafts 294 are shown in FIGS. 11A-11D as sized significantly smaller than the width of the slots 296. The slots 296 extend generally vertically along the rear uprights 114 between an upper slot end 298 and a transition slot region 300, and extend at an angle from the transition slot region 300 to a lower slot end 302. The slots 296 are disposed vertically between the rear seat axis RSA and the rear arm axis RAA in the illustrated version. In some configurations, the folding link 288, the slots 296, and or other portions of the folding lock mechanism 284 may be similar to as is disclosed in U.S. Pat. No. 6,648,343, previously referenced. Other configurations are contemplated.

In the representative version illustrated herein, the folding lock mechanism 284 is configured to selectively retain the keeper shafts 294 adjacent to the upper slot ends 298 of the slots 296 in the stow lock configuration 284A (see FIG. 11A), and to selectively retain the keeper shafts 294 adjacent to the lower slot ends 302 of the slots 296 in the use lock configuration 284B (see FIG. 11C). To this end, keeper elements 304 are coupled to the keeper shafts 294 and move within upright channels 306 formed in the rear uprights 114. Here too, a carriage 308 is slidably supported within the upright channels 306 for movement relative to the slots 296 in response to engagement of the folding lock release 286 via the caregiver. A folding linkage assembly 310 generally extends in force-translating relationship between the folding lock release 286 and the carriage 308. While not shown in detail, the folding lock release 286 is supported by the back section 106 and moves in response to engagement by the caregiver, and the folding linkage assembly 310 comprises one or more components which may extend through the back section 106 and into the rear uprights 114 in order to facilitate movement of the carriage 308 within the upright channels 306 in response to user engagement of the folding lock release 286.

The carriage 308 generally defines an upper pocket 312 shaped to receive and accommodate the keeper element 304 when the folding lock mechanism 284 is in the stow lock configuration 284A with the patient transport apparatus 100 arranged in the stowed configuration WC, and a lower pocket 314 shaped to receive and accommodate the keeper element 304 when the folding lock mechanism 284 is in the use lock configuration 284B with the patient transport apparatus 100 arranged in the chair configuration CC or in the stair configuration SC. In the illustrated version, the upper pocket 312 has a generally U-shaped profile and the lower pocket 314 has a generally V-shape profile which defines a upper ramp 316 and a lower ramp 318,

As shown in FIG. 11A, engagement between the keeper element 304 and the upper pocket 312 of the carriage 308 prevents movement of the keeper shaft 294 along the slot 296. When the caregiver engages the folding lock release 286 to move the folding lock mechanism 284 out of the stow lock configuration 284A, the corresponding movement of the folding linkage assembly 310 causes the carriage 308 to travel vertically upwardly within the upright channel 306 until the keeper element 304 comes out of engagement with the upper pocket 312, as shown in FIG. 11B. Here, the keeper shaft 294 can subsequently traverse the slot 296 toward the lower slot end 302 in order to move to the use lock configuration 284B depicted in FIG. 11C. While not shown, it will be appreciated that the carriage 308, the folding linkage assembly 310, and or the folding lock release 286 may comprise one or more biasing elements arranged to urge the carriage 308 vertically down the upright channel 306.

When in the use lock configuration 284B depicted in FIG. 11C, the keeper shaft 294 is disposed adjacent to the lower slot end 302 of the slot 296 such that the keeper element 304 is generally disposed adjacent to or otherwise in the lower pocket 314, such as in contact with the upper ramp 316 and the lower ramp 318. Here, the keeper element 304 is retained via a folding lock biasing element 320 (depicted schematically) that is coupled to the rear upright 114 (e.g., disposed within the upright channel 306). The engagement between the keeper element 304 and folding lock biasing element 320 urges the keeper shaft 294 toward the lower slot end 302 of the slot 296 to maintain operation in the use lock configuration 284B depicted in FIG. 11C. When the caregiver engages the folding lock release 286 to move the folding lock mechanism 284 out of the use lock configuration 284B, the corresponding movement of the folding linkage assembly 310 causes the carriage 308 to travel vertically upwardly within the upright channel 306. Here, as the lower ramp 318 of the carriage 308 defined by the lower pocket 314 moves together with the keeper element 304 disposed in engagement therewith, the folding lock biasing element 320 compresses as the keeper shaft 294 travels out of the transition slot region 300, as shown in FIG. 11D. Here, the keeper shaft 294 can subsequently traverse the slot 296 toward the upper slot end 298 in order to move to the stow lock configuration 284A depicted in FIG. 11A. It will be appreciated that the folding lock mechanism 284 could be configured in other ways sufficient to releasably lock the patient transport apparatus in the stowed configuration WC, the stair configuration SC, and the chair configuration CC, and it is contemplated that one lock mechanism could lock the patient transport apparatus 100 in the stowed configuration WC while a different lock mechanism could lock the patient transport apparatus 100 in the stair configuration SC and/or the chair configuration CC. Other configurations are contemplated.

FIGS. 12A-12I successively depict exemplary steps of transporting a patient supported on the patient transport apparatus 100 down stairs ST. In FIG. 12A, a first caregiver is shown engaging the pivoting handle assemblies 130 in the engagement position 130B to illustrate approaching stairs ST while the patient transport apparatus 100 is moved along floor surfaces FS in the chair configuration CC. FIG. 12B depicts a second caregiver engaging the front handle assemblies 128 after having moved them to the extended position 128B. In FIG. 12C, the patient transport apparatus 100 has been moved closer to the stairs ST with the first caregiver still engaging the pivoting handle assemblies 130 and with the second caregiver still engaging the front handle assemblies 128. In FIG. 12D, the first caregiver has moved the handle assembly 132 to the extended position 132B as the second caregiver continues to engage the front handle assemblies 128.

In FIG. 12E, the first caregiver has engaged the deployment lock release 166 to move the patient transport apparatus 100 out of the chair configuration CC and into the stair configuration SC. Here, the track assemblies 154 are shown arranged between the retracted position 154A and the deployed position 154B, and the rear wheels 152 move closer to the front wheels 122, as the first caregiver pulls the track assemblies 154 away from the back section 106. In FIG. 12F, the patient transport apparatus 100 is shown in the stair configuration SC with the track assemblies 154 arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport apparatus 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of patient's center of gravity has not changed significantly relative to the support structure 102, the longitudinal distance taken normal to gravity which extends between the patient's center of gravity and the location at which the rear wheels 152 contact the floor surface FS has shortened considerably. Because of this, the process of “tilting” the patient transport apparatus 100 (e.g., about the rear wheels 152) to transition toward contact between the track assemblies 154 and the stairs ST, as depicted in FIG. 12G, is significantly more comfortable for the patient than would otherwise be the case if the patient transport apparatus 100 were “tilted” about the rear wheels 152 from the chair configuration CC (e.g., with the rear wheels 152 positioned further away from the front wheels 122). Put differently, the arrangement depicted in FIG. 12G is such that the patient is much less likely to feel uncomfortable, unstable, or as if they are “falling backwards” during the “tilting” process. Here too, the caregivers are afforded with similar advantages in handling the patient transport apparatus 100, as the arrangement of the rear wheel 152 described above also makes the “tilting” process easier to control and execute.

In FIG. 12H, the caregivers are shown continuing to support the patient transport apparatus 100 in the stair configuration SC as the belts 156 of the track assemblies 154 are brought into contact with the edge of the top stair ST. In FIG. 12I, the caregivers are shown continuing to support the patient transport apparatus 100 in the stair configuration SC as the belts 156 of the track assemblies 154 contact multiple stairs ST during descent.

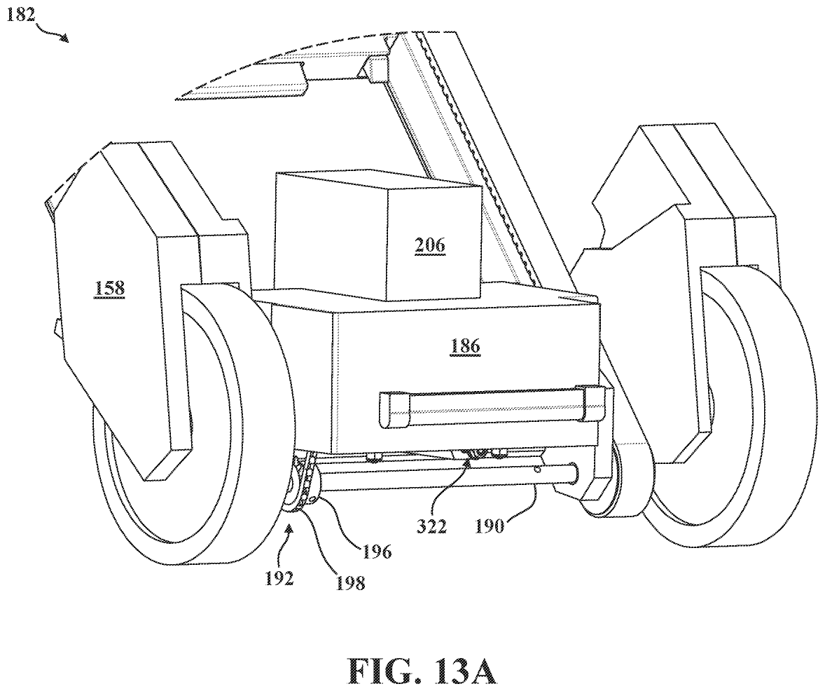

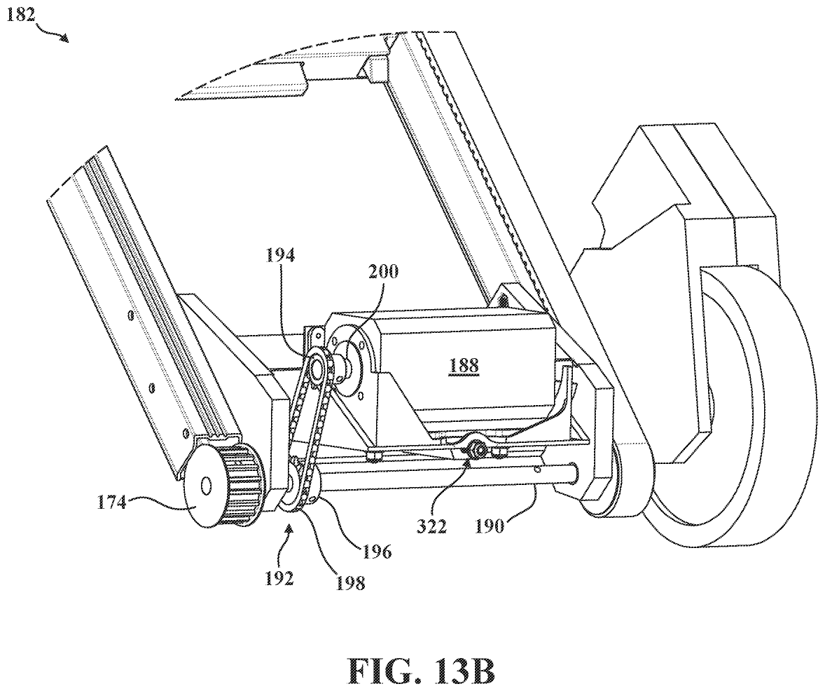

Referring now to FIGS. 13A-13B, portions of the drive system 182 are depicted without the full patient transport assembly 100 in FIG. 13A, and additional components have been removed in FIG. 13B for illustrative purposes. As shown in FIG. 13B, in some configurations, the motor 188 is supported on an adjustable platform 322 that is movable relative to the drive frame 184 to adjust slack in the endless chain 198 (adjustment not shown in detail). This arrangement helps to optimize power density and minimize weight in the drive system 182. It will be appreciated that this arrangement could be utilized with other type of geartrains 192, such as where a belt drive (not shown) would replace the endless chain 198. Other configurations are contemplated.

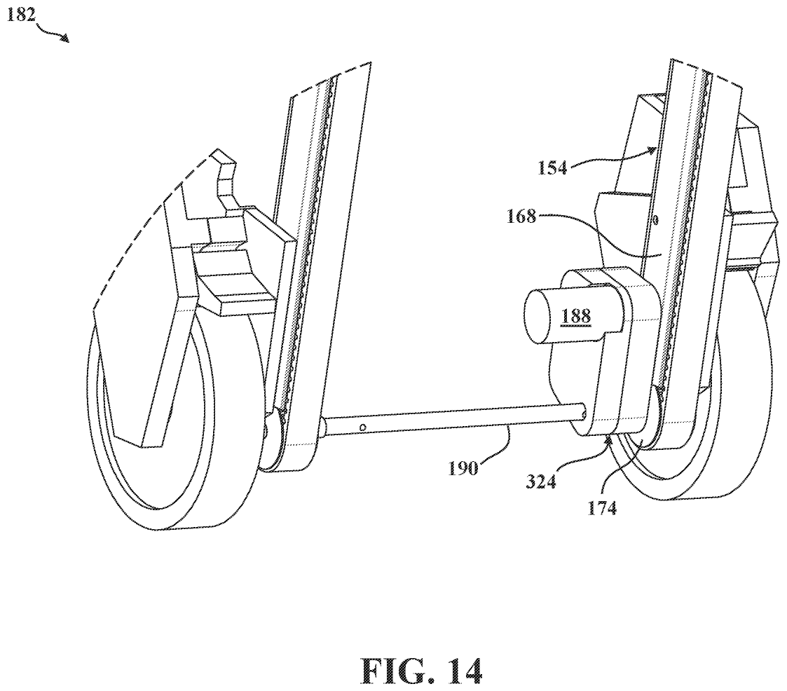

Referring now to FIG. 14, another version of the drive system 182 is shown depicted without the full patient transport assembly 100. In this version, the geartrain 192 is configured with a direct drive gearbox 324 coupled to one of the rails 168 of the track assembly 154. Here, the drive axle 190 extends through the direct drive gearbox 324, and the motor 188 is coupled to the direct drive gearbox 324. It will be appreciated that the direct drive gearbox 324 may comprise various arrangements of gears (not shown) to facilitate adjusting the speed/torque between the motor 188 and the drive axle 190. Other configurations are contemplated.

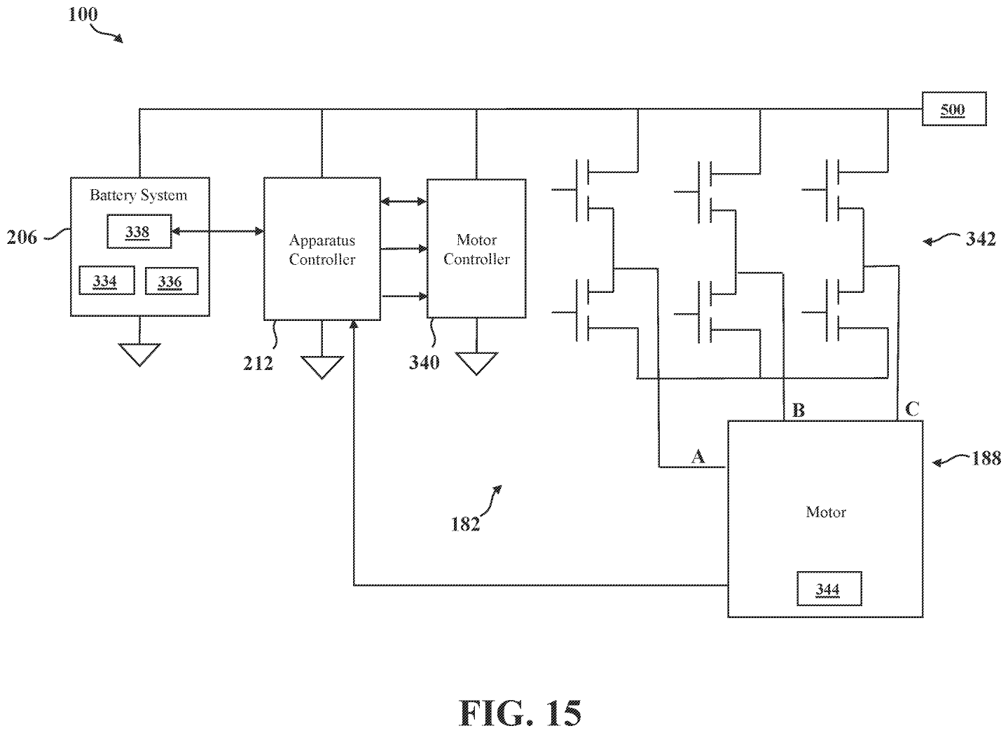

Referring now to FIGS. 15-17, the apparatus controller 212 is disposed in communication with the motor 188 and the battery system 206. The apparatus controller 212 is configured to monitor power consumption associated with the patient transport apparatus 100, and is disposed in communication with the motor 188 and the battery system 206. In the event that power consumption is greater than expected and/or in response to detecting a battery fault event which, for example may be an indication of a power short or downstream failure, the apparatus controller 212 is configured to initiate a shutdown sequence 350 to prevent power shorting, downstream failures, and/or other types of potential damage. The shutdown sequence 350 will be discussed in greater detail below.

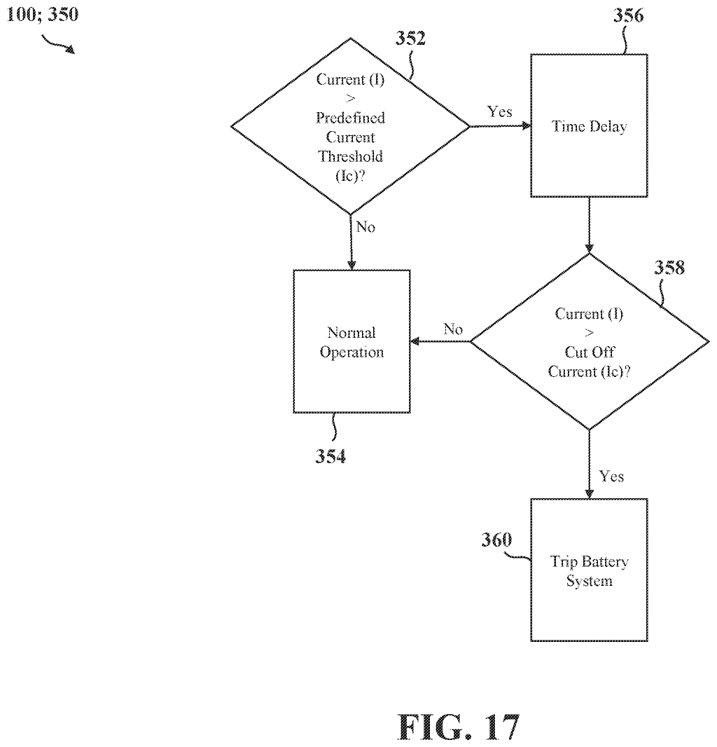

The battery system 206 includes a power output 334, one or more battery cells 336 configured for power transmission, and a battery controller 338 configured to enable power transmission from one or more battery cells 336 to the power output 334. The battery controller 338 is configured to enable power transmission in response to power drawn across the power output 334 being below a predefined current threshold IC (for example, see FIG. 17). The predefined current threshold IC may be referred to a current cutoff threshold in some configurations. It will be appreciated that the predefined current threshold IC may be defined as a constant, or may be a variable (e.g., defined by or within a range of discrete values, defined relative to signals from one or more sensors, and the like). In some versions, the predefined current threshold IC vary based on the number of powered devices associated with the patient transport apparatus 100, or an operating mode of the patient transport apparatus 100. Other configurations are contemplated.

Referring to FIG. 15, the drive system 182 includes the motor 188 and a motor controller 340. The battery controller 338, the motor controller 340, and the motor 188 are in communication with the apparatus controller 212. The motor 188 is disposed in rotational communication with the track assembly 154 to control movement of the patient transport apparatus 100. The motor 188 comprises one or more windings 342 and at least one feedback sensor 344. In some configurations, the motor 188 may be realized as a three-phase brushless DC motor including three windings 342 with leads A, B, C, however other configurations are contemplated (e.g., with a different arrangement of windings). As mentioned above, the drive system 182 is operable between a current sink mode MC, and an operational mode MO for generating rotational torque to control movement of the patient transport apparatus 100.

As noted above, during use in the operational mode MO, movement of the belt 156 can be controlled or otherwise limited via the apparatus controller 212 by driving one or more windings 342 in various ways, such as to prevent or otherwise control movement of the patient transport apparatus 100 along stairs ST. Depending on the specific configuration of the motor 188, it may take a considerable amount of torque to effect unintended rotation of the motor 188 while windings 342 are driven dynamically, such as based on signals from sensors (e.g., based on sensed rotation of the motor 188, based on the input current of the battery system 206, and the like).

In some scenarios, including when the patient transport apparatus 100 is being operated with the belt 156 engaging along stairs ST as well as when the patient transport apparatus 100 is not being used in a way which moves the belt 156, the existence of adverse operating and/or environmental conditions (e.g., excessive applied weight, high temperatures, physical damage, moisture, contamination, and the like) may necessitate disconnection of the battery system 206 in order to prevent or otherwise mitigate damage to various components of the patient transport apparatus 100. To this end, the apparatus controller 212 can be operated in the current sink mode MC to “misfire” the motor 188 which, in turn, causes the battery controller 338 to interrupt power transmission from one or more battery cells 336 to the power output 334, whereby the battery system 206 shuts itself off to prevent damage to itself and/or to other components of the patient transport apparatus 100. More specifically, during operation in the current sink mode MC, the apparatus controller 212 misfires the motor 188 by shorting windings 342 such that two of the three phases of the motor 188 are used as an inductive current sync which exceeds the cut-off level of the battery system 206 itself. By operating the motor 188 in this way, the battery system 206 can be triggered to shut off without having to directly communicate with the apparatus controller 212.

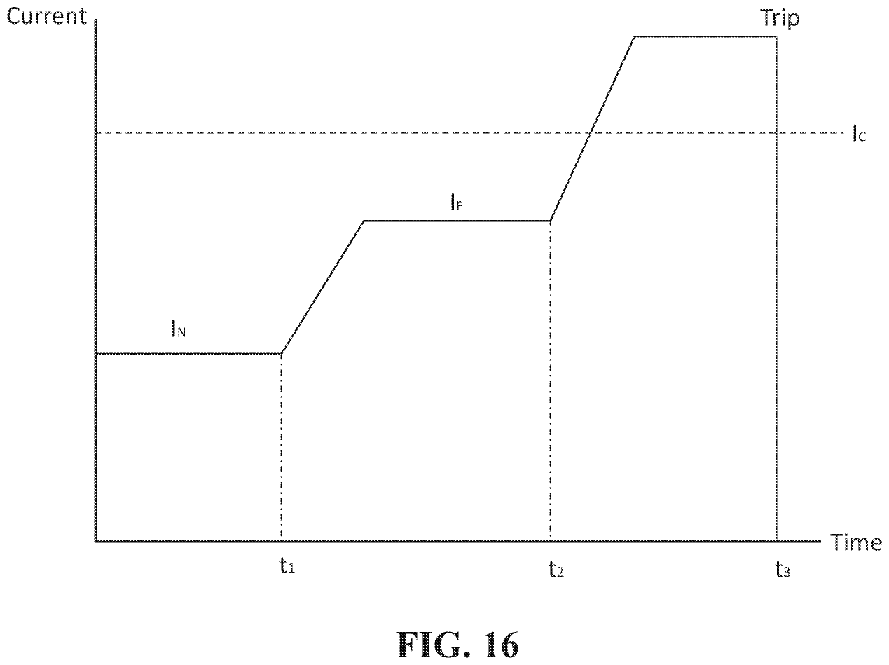

The apparatus controller 212 is configured to monitor power transmission associated with the battery system 206 and activate operation of the drive system 182 in the current sink mode MC to cause the battery controller 338 to interrupt power supply upon determining an input current of the battery system 206 is greater than the predefined current threshold IC by comparing the input current of the battery system 206 to the predefined current threshold IC (see FIG. 16). The current under normal conditions IN is shown at the first timestamp T1. If a fault condition occurs and the current increases to a fault condition IF beyond the current threshold IC at the second timestamp T2, and/or continues to increase past the predefined current threshold IC, the shutdown sequence 350 described in greater detail below is triggered. Said differently, the shutdown sequence 350 is triggered in response to the apparatus controller 212 determining that the input current of the battery system 206 is greater than the predefined current threshold IC. In this way, the apparatus controller 212 is configured to operate the drive system 182 in the current sink mode MC causing the battery controller 338 to interrupt power supply.

While the drive system 182 is operating in the current sink mode MC, the apparatus controller 212 is configured to set a parameter P of the drive system 182. For example, in some configurations, the apparatus controller 212 is configured to set or lock parameters P associated with the feedback sensor 344 in order to effect control of the motor 188 (e.g., to inhibit motor commutation). In some configurations, the apparatus controller 212 may be configured to set, define, or otherwise interpret specific signals and/or parameters P associated with the feedback sensor 344 and/or the motor 188 more generally. Other configurations and parameter settings are contemplated. In some versions, the feedback sensor 344 may be a hall sensor configured to monitor and generate output signals or feedback signals representative of a rotational position of a rotor of the motor 188. Here, the feedback sensor 344 generates signals that vary with a sensed magnetic field adjacent a rotor of the motor 188 which can be used to determine movement of the rotor. Although the drawings show one feedback sensor 344, it will be appreciated that the motor 188 may include any number of feedback sensors 344, which may be integrated with the motor 188 or may be separate from the motor 188. Other configurations are contemplated.

Referring to FIG. 17, an exemplary flow diagram for a battery fault event is provided. The shutdown sequence 350 is shown. At step 352, the apparatus controller 212 determines whether the input current of the battery system 206 is greater than the predefined current threshold IC. If the input current is not greater, the sequence 350 moves to step 354 with the patient transport apparatus 100 operating under normal operations. Under normal operations, the drive system 182 may be configured to operate in the operational mode MO in response to the apparatus controller 212 determining the input current of the battery system 206 is less than or equal to the predefined current threshold IC. While in operational mode MO, the drive system 182 may be utilized to control the motor 188 in an active mode MA by controlling the motor 188 to limit movement of the belt 156 to facilitate a controlled descent of the patient transport apparatus 100 along stairs ST.

If the input current is greater than the current threshold IC, the sequence 350 moves to step 356 wherein the apparatus controller 212 may change operation of the drive system 182 at a predetermined time, which may be a predetermined time interval or a variable interval (e.g., associated with signals from a sensor). Here, after the predetermined time has lapsed, the sequence moves to step 358 whereby the apparatus controller 212 determines whether the input current of the battery system 206 is still greater than the predefined current threshold IC. If the input current is not greater, the sequence 350 moves to back to step 354 where the patient transport apparatus 100 is operating under normal operations, such as in the operational mode MO. If the input current is greater, the sequence 350 moves to step 360 where the battery system 206 is tripped. In other words, the drive system 182 is operating in the current sink mode MC as described above.

In the event the drive system 182 is operating in the current sink mode MC and/or the operation of the drive system 182 changes, in some configurations, the apparatus controller 212 may be configured to provide an indication (e.g., via the user interface 204) that the input current of the battery system 206 is greater than the predefined current threshold IC. Indications may include any audio and/or visual indication. Other configurations are contemplated.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### Clauses

I. A patient transport apparatus comprising:
a support structure;
a battery system coupled to the support structure, the battery system including:
   a power output,
   one or more battery cells configurable for power transmission, and
   a battery controller in communication with one or more battery cells, the battery controller configured to enable power transmission from one or more battery cells to the power output in response to power draw across the power output being below a predefined current threshold;
a track assembly having a movable belt, the track assembly being operatively attached to the support structure and arranged for selective operation between a retracted position disposed adjacent the support structure and a deployed position extending to engage stairs;
an apparatus power circuit for operating one or more powered devices including a drive system including a motor disposed in rotational communication with the track assembly to control movement of the patient transport apparatus along stairs when the track assembly operates in the deployed position, the drive system operable between:
   a current sink mode, and
   an operational mode for generating rotational torque to control movement of the patient transport apparatus; and
an apparatus controller disposed in communication with the motor and the battery system and configured to monitor the power transmission and to operate the drive system in the current sink mode causing the battery controller to interrupt power supply upon determining an input current of the battery system is greater than the predefined current threshold by comparing the input current of the battery system to the predefined current threshold.
II. The patient transport apparatus of clause I, wherein the motor of the drive system comprises one or more windings.
III. The patient transport apparatus of clause II, wherein the apparatus controller is configured to control the motor to limit movement of the belt by driving one or more windings.
IV. The patient transport apparatus of clause II, wherein the apparatus controller is configured to control the motor to limit movement of the belt by driving one or more windings upon determining the input current of the battery system is greater than the predefined current threshold.
V. The patient transport apparatus of clause II, wherein the motor of the drive system is a three-phase brushless DC motor including three windings, and wherein the apparatus controller is configured to control the three-phase brushless DC motor to limit movement of the belt by driving two of the three windings.
VI. The patient transport apparatus of clause II, wherein the battery controller is configured to interrupt power transmission from one or more battery cells to the power output in response to the apparatus controller driving one or more windings of the motor.
VII. The patient transport apparatus of any of clauses I-VI, wherein the drive system is operating in the current sink mode, the battery controller is configured to interrupt power transmission from one or more battery cells to the power output.
VIII. The patient transport apparatus of any of clauses I-VII, wherein the drive system is operating in the current sink mode, the apparatus controller is configured to set a parameter of the drive system.
IX. The patient transport apparatus of clause VIII, wherein setting the parameter of the drive system is associated with a feedback sensor coupled to the motor.
X. The patient transport apparatus of clause IX, wherein the feedback sensor is configured to generate feedback signals representative of a rotational position associated with the motor, and the apparatus controller is further configured to change the feedback signals.
XI. The patient transport apparatus of any of clauses I-X, wherein the drive system is configured to operate in the operational mode in response to the apparatus controller determining the input current of the battery system is less than or equal to the predefined current threshold.
XII. The patient transport apparatus of any of clauses I-XI, wherein the apparatus controller is configured to change operation of the drive system from the operational mode to the current sink mode in response to determining the input current of the battery system is greater than the predefined current threshold.
XIII. The patient transport apparatus of any of clauses I-XII, wherein the drive system is operating in the current sink mode, the drive system is configured to control the motor in a hold mode by controlling the motor to limit movement of the belt to maintain the patient transport apparatus in a substantially fixed position.
XIV. The patient transport apparatus of any of clauses I-XIII, wherein the drive system is operating in the operational mode, the drive system is configured to control the motor in an active mode by controlling the motor to limit movement of the belt to facilitate a controlled descent of the patient transport apparatus along stairs.
XV. The patient transport apparatus of any of clauses I-XIV, wherein upon determining the input current of the battery system is greater than the predefined current threshold, the apparatus controller is configured to change operation of the drive system at a predetermined time after determining the input current of the battery system is greater than the predefined current threshold.
XVI. The patient transport apparatus of clause XV, wherein after the predetermined time, the apparatus controller is configured to determine whether the input current of the battery system is greater than the predefined current threshold and to change operation of the drive system to the current sink mode from the operational mode in response to determining the input current of the battery system is greater than the predefined current threshold.
XVII. The patient transport apparatus of any of clauses I-XVI, wherein the apparatus controller is configured to short the apparatus power circuit in response to power draw across the power output being above the predefined current threshold.
XVIII. The patient transport apparatus of clause XVII, wherein the apparatus controller shorts the apparatus power circuit, the battery controller is configured to interrupt power transmission from one or more battery cells.
XIX. The patient transport apparatus of any of clauses I-XVIII, further comprising a carrier assembly arranged for movement relative to the support structure between a chair configuration and a stair configuration, the carrier assembly including a plurality of wheels for selectively engaging floor surfaces.
XX. The patient transport apparatus of any of clauses I-XIX, wherein the apparatus controller is configured to provide an indication that the input current of the battery system is greater than the predefined current threshold.

What is claimed is:

1. A patient transport apparatus comprising:
a support structure;
a battery system coupled to the support structure, the battery system including:
a power output,
one or more battery cells configurable for power transmission, and
a battery controller in communication with one or more battery cells, the battery controller configured to enable power transmission from one or more battery cells to the power output in response to power draw across the power output being below a predefined current threshold;
a track assembly having a movable belt, the track assembly being operatively attached to the support structure and arranged for selective operation between a retracted position disposed adjacent the support structure and a deployed position extending to engage stairs;
an apparatus power circuit for operating one or more powered devices including a drive system including a motor disposed in rotational communication with the track assembly to control movement of the patient transport apparatus along stairs when the track assembly operates in the deployed position, the drive system operable between:
a current sink mode, and
an operational mode for generating rotational torque to control movement of the patient transport apparatus; and
an apparatus controller disposed in communication with the motor and the battery system and configured to monitor the power transmission and to operate the drive system in the current sink mode causing the battery controller to interrupt power supply upon determining an input current of the battery system is greater than the predefined current threshold by comparing the input current of the battery system to the predefined current threshold.

2. The patient transport apparatus of claim 1, wherein the motor of the drive system comprises one or more windings.

3. The patient transport apparatus of claim 2, wherein the apparatus controller is configured to control the motor to limit movement of the belt by driving one or more windings.

4. The patient transport apparatus of claim 2, wherein the apparatus controller is configured to control the motor to limit movement of the belt by driving one or more windings upon determining the input current of the battery system is greater than the predefined current threshold.

5. The patient transport apparatus of claim 2, wherein the motor of the drive system is a three-phase brushless DC motor including three windings, and wherein the apparatus controller is configured to control the three-phase brushless DC motor to limit movement of the belt by driving two of the three windings.

6. The patient transport apparatus of claim 2, wherein the battery controller is configured to interrupt power transmission from one or more battery cells to the power output in response to the apparatus controller driving one or more windings of the motor.

7. The patient transport apparatus of claim 1, wherein the drive system is operating in the current sink mode, the battery controller is configured to interrupt power transmission from one or more battery cells to the power output.

8. The patient transport apparatus of claim 1, wherein the drive system is operating in the current sink mode, the apparatus controller is configured to set a parameter of the drive system.

9. The patient transport apparatus of claim 8, wherein setting the parameter of the drive system is associated with a feedback sensor coupled to the motor.

10. The patient transport apparatus of claim 9, wherein the feedback sensor is configured to generate feedback signals representative of a rotational position associated with the motor, and the apparatus controller is further configured to change the feedback signals.

11. The patient transport apparatus of claim 1, wherein the drive system is configured to operate in the operational mode in response to the apparatus controller determining the input current of the battery system is less than or equal to the predefined current threshold.

12. The patient transport apparatus of claim 1, wherein the apparatus controller is configured to change operation of the drive system from the operational mode to the current sink mode in response to determining the input current of the battery system is greater than the predefined current threshold.

13. The patient transport apparatus of claim 1, wherein the drive system is operating in the current sink mode, the drive system is configured to control the motor in a hold mode by controlling the motor to limit movement of the belt to maintain the patient transport apparatus in a substantially fixed position.

14. The patient transport apparatus of claim 1, wherein the drive system is operating in the operational mode, the drive system is configured to control the motor in an active mode by controlling the motor to limit movement of the belt to facilitate a controlled descent of the patient transport apparatus along stairs.

15. The patient transport apparatus of claim 1, wherein upon determining the input current of the battery system is greater than the predefined current threshold, the apparatus controller is configured to change operation of the drive system at a predetermined time after determining the input current of the battery system is greater than the predefined current threshold.

16. The patient transport apparatus of claim 15, wherein after the predetermined time, the apparatus controller is configured to determine whether the input current of the battery system is greater than the predefined current threshold and to change operation of the drive system to the current sink mode from the operational mode in response to determining the input current of the battery system is greater than the predefined current threshold.

17. The patient transport apparatus of claim 1, wherein the apparatus controller is configured to short the apparatus power circuit in response to power draw across the power output being above the predefined current threshold.

18. The patient transport apparatus of claim 17, wherein the apparatus controller shorts the apparatus power circuit, the battery controller is configured to interrupt power transmission from one or more battery cells.

19. The patient transport apparatus of claim 1, further comprising a carrier assembly arranged for movement relative to the support structure between a chair configuration and a stair configuration, the carrier assembly including a plurality of wheels for selectively engaging floor surfaces.

20. The patient transport apparatus of claim 1, wherein the apparatus controller is configured to provide an indication that the input current of the battery system is greater than the predefined current threshold.
